(19) United States
(12) Patent Application Publication
(10) Pub. No.: US 2024/0281571 A1
(43) Pub. Date: Aug. 22, 2024

(54) EFFICIENT AUTOMATIC DESIGN OF PHYSICAL MACHINES WITH MOVING PARTS

(71) Applicants: Northwestern University, Evanston, IL (US); Massachusetts Institute of Technology, Cambridge, MA (US); The University of Vermont, Burlington, VT (US)

(72) Inventors: Samuel Kriegman, Evanston, IL (US); David S. Matthews, Evanston, IL (US); Joshua Bongard, Burlington, VT (US); Andrew Spielberg, Cambridge, MA (US); Daniela Rus, Cambridge, MA (US)

(21) Appl. No.: 18/585,006

(22) Filed: Feb. 22, 2024

Related U.S. Application Data
(60) Provisional application No. 63/486,413, filed on Feb. 22, 2023.

(51) Int. Cl. G06F 30/17

(52) U.S. Cl. CPC G06F 30/17

(57) ABSTRACT

In certain aspects, a computer-implemented method includes generating a candidate structure based on constituent elements and a target behavior. The method includes simulating, in a prespecified environment, behavior of the candidate structure under prespecified constraints. The method includes evaluating the behavior of the candidate structure, during the simulating, under the prespecified constraints. The method includes calculating a gradient of the behavior of the candidate structure simulated under the prespecified constraints with respect to parameters associated with the constituent elements. The method includes optimally adjusting, based on the calculated gradient, the parameters for improving the behavior of the candidate structure under the prespecified constraints. The method includes applying the adjusted parameters to the candidate structure for generating an adjusted candidate structure. The method includes performing iteratively, until a performance threshold associated with the target behavior is reached, steps on the adjusted candidate structure of simulating, evaluating, calculating, optimally adjusting, and applying.

### CROSS-REFERENCE TO RELATE APPLICATION

The present application claims the benefit of priority under 35 U.S.C. § 119 from U.S. Provisional Patent Application Ser. No. 63/486,413 entitled “EFFICIENT AUTOMATIC DESIGN OF PHYSICAL MACHINES WITH MOVING PARTS,” filed on Feb. 22, 2023, the disclosure of which is hereby incorporated by reference in its entirety for all purposes.

### TECHNICAL FIELD

The present disclosure generally relates to robotics and artificial intelligence, and more specifically relates to efficient automatic design of physical machines with moving parts.

### BACKGROUND

Robots are notoriously difficult to design because of complex interdependencies between their physical structure, sensory and motor layouts, and behavior. Despite this, almost every detail of every robot built to date has been manually determined by a human designer after several months or years of iterative ideation, prototyping, and testing. Inspired by evolutionary design in nature, the automated design of robots using evolutionary algorithms has been attempted for two decades, but it too remains inefficient: days of supercomputing are required to design robots in simulation that, when manufactured, exhibit desired behavior.

### SUMMARY

According to certain aspects of the present disclosure, a computer-implemented method is provided. The method includes generating a candidate structure based on constituent elements and a target behavior, wherein the constituent elements comprise a physical structure and at least one dynamic component. The method includes simulating, in a prespecified environment, behavior of the candidate structure under prespecified constraints of the prespecified environment. The method includes evaluating, based on a predefined metric, the behavior of the candidate structure, during the simulating, under the prespecified constraints. The method includes calculating a gradient of the behavior of the candidate structure simulated under the prespecified constraints with respect to parameters associated with the physical structure and parameters of behavioral control associated with the at least one dynamic component. The method includes optimally adjusting, based on the gradient of the behavior of the candidate structure simulated under the prespecified constraints that was calculated, the parameters associated with the physical structure and the parameters of behavioral control associated with the at least one dynamic component for improving the behavior of the candidate structure under the prespecified constraints, wherein optimally adjusting produces adjusted parameters. The method includes applying the adjusted parameters to the candidate structure for generating an adjusted candidate structure. The method includes performing iteratively, until a performance threshold associated with the target behavior is reached, steps of: simulating, in the prespecified environment, adjusted behavior of the adjusted candidate structure under the prespecified constraints of the prespecified environment; evaluating the adjusted behavior of the adjusted candidate structure, during the simulating, under the prespecified constraints; calculating an adjusted gradient of the adjusted behavior of the adjusted candidate structure simulated under the prespecified constraints with respect to the adjusted parameters; optimally adjusting, based on the adjusted gradient of the adjusted behavior of the adjusted candidate structure simulated under the prespecified constraints that was calculated, the adjusted parameters, wherein optimally adjusting the adjusted parameters produces re-adjusted parameters; and applying the re-adjusted parameters to the adjusted candidate structure.

In certain aspects, the at least one dynamic component comprises at least one actuator.

In certain aspects, the parameters of behavioral control associated with the at least one dynamic component comprise one of a presence, a size, a shape, and a material property.

In certain aspects, the step of generating the candidate structure based on constituent elements comprises generating the candidate structure based on prespecified constituent elements.

In certain aspects, the performance threshold comprises one of a prespecified number of iterations, a prespecified time period, a predetermined performance of the candidate structure, an improvement threshold identifying no further behavioral improvements of the candidate structure, and a prespecified amount of computing resources.

In certain aspects, the step of performing iteratively, until the performance threshold associated with the target behavior is reached, further comprises the step of optionally calibrating, after applying the re-adjusted parameters to the adjusted candidate structure, the prespecified constraints of the prespecified environment.

In certain aspects, the step of evaluating, based on the predefined metric, the behavior of the candidate structure, during the simulating, under the prespecified constraints is performed via a graphics processing unit.

In certain aspects, the candidate structure models one of an appliance, an instrument, a material, an implant, a wearable, a biological, a vehicle, a turbine, and a robot.

In certain aspects, the step of calculating the gradient of the behavior of the candidate structure simulated under the prespecified constraints with respect to the parameters associated with the physical structure and the parameters of behavioral control associated with the at least one dynamic component further comprises calculating the gradient via an automatic differentiation scheme.

In certain aspects, the step of generating the candidate structure based on constituent elements and the target behavior further comprises generating the candidate structure based on constituent elements via a random distribution.

According to certain aspects of the present disclosure, a system is provided. The system includes one or more memories comprising instructions and one or more processors configured to execute the instructions which, when executed, cause the one or more processors to generate a candidate structure based on constituent elements and a target behavior, wherein the constituent elements comprise a physical structure and at least one dynamic component. The one or more processors is configured to execute the instructions which, when executed, cause the one or more processors to simulate, in a prespecified environment, behavior of the candidate structure under prespecified constraints of the prespecified environment. The one or more processors is configured to execute the instructions which, when executed, cause the one or more processors to evaluate, based on a predefined metric, the behavior of the candidate structure, during the simulating, under the prespecified constraints. The one or more processors is configured to execute the instructions which, when executed, cause the one or more processors to calculate a gradient of the behavior of the candidate structure simulated under the prespecified constraints with respect to parameters associated with the physical structure and parameters of behavioral control associated with the at least one dynamic component. The one or more processors is configured to execute the instructions which, when executed, cause the one or more processors to optimally adjust, based on the gradient of the behavior of the candidate structure simulated under the prespecified constraints that was calculated, the parameters associated with the physical structure and the parameters of behavioral control associated with the at least one dynamic component for improving the behavior of the candidate structure under the prespecified constraints for producing adjusted parameters. The one or more processors is configured to execute the instructions which, when executed, cause the one or more processors to apply the adjusted parameters to the candidate structure for generating an adjusted candidate structure. The one or more processors is configured to execute the instructions which, when executed, cause the one or more processors to perform iteratively, until a performance threshold associated with the target behavior is reached, steps of simulating, in the prespecified environment, adjusted behavior of the adjusted candidate structure under the prespecified constraints of the prespecified environment; evaluating the adjusted behavior of the adjusted candidate structure, during the simulating, under the prespecified constraints; calculating an adjusted gradient of the adjusted behavior of the adjusted candidate structure simulated under the prespecified constraints with respect to the adjusted parameters; optimally adjusting, based on the adjusted gradient of the adjusted behavior of the adjusted candidate structure simulated under the prespecified constraints that was calculated, the adjusted parameters, wherein optimally adjusting the adjusted parameters produces re-adjusted parameters; and applying the re-adjusted parameters to the adjusted candidate structure.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF DRAWINGS

The disclosure is better understood with reference to the following drawings and description. The elements in the figures are not necessarily to scale, emphasis instead being placed upon illustrating the principles of the disclosure. Moreover, in the figures, like-referenced numerals may designate to corresponding parts throughout the different views.

FIG. 1A illustrates a comparison of a gradient-based approach of the present disclosure with traditional approaches, which required thousands of simulations or hundreds of physical prototypes.

FIG. 1B illustrates a mobile robot efficiently and automatically designed according to certain aspects of the present disclosure.

FIG. 1C illustrates a randomly-generated morphology (gray body shape with red musculature) that begins a design process according to certain aspects of the present disclosure.

FIGS. 1D-1L illustrates nine design revisions, respectively, from the randomly-generated morphology of FIG. 1C.

FIG. 1M illustrates a progression from the first, randomly-configured robot of FIG. 1C through to the ninth design revision of FIG. 1L.

FIGS. 1N and 1O illustrate a set of 3D-printed molds for an initial design attempt and a final design attempt, respectively.

FIG. 1P illustrates a pneumatic tube glued into a lower robot half (blue) mold with Sil-Poxy.

FIG. 1Q illustrates an upper robot half (yellow) in FIG. 1P being silicone onto the lower robot half of FIG. 1P, and illustrates the combined upper and lower robot halves, after curing, being rotated into an upright posture and connected to a pneumatic pressure control system, accordingly to certain aspects of the present disclosure.

FIG. 2A illustrates a robot composed of particles (gray), internal voids (circle; only one shown), and muscle patches (not shown). Voids reduce both the mass and elasticity of all particles within them. Particles closer to the center are reduced in mass/elasticity more; those very near the center are deleted entirely.

FIG. 2B illustrates, during simulation, each particle's influence on the robot's behavior is tracked. After simulation, this information is used to calculate how each particle should be changed to improve the robot's behavior during the next simulation. In a simple example, such change is intuitive: if a robot incapable of moving should “move” to the right, the mass of particles to the left should be decreased (−) and those to the right should be increased (+).

FIG. 2C illustrates desired mass/elasticity changes of FIG. 2B, which dictate void movement. Particles that should have less and more mass/elasticity pull and push on nearby voids, respectively. Voids respond to these pressures by moving (arrow) and resizing (adjusting their radius; not shown), and then dictate the new masses/elasticities of all particles within them; previously-deleted particles may be recovered (dark gray). Using voids to indirectly affect particle masses/elasticities allows the design method to smoothly alter mass, elasticity, shape, and topology across the robot's body.

FIG. 2D illustrates muscle patches (red) cause particles within them to volumetrically oscillate during simulation at the same phase, pushing and pulling against neighboring particles. As with voids, how the particles should have oscillated differently to improve behavior are calculated and used to move the muscle patches.

FIG. 2E illustrates sixty-four movable and resizable voids and 64 movable muscles were randomly positioned within the particle grid (Attempt 1), the resulting design was evaluated in simulation for locomotive ability, and the effect of each void and muscle on fitness was tracked. After simulation, how each void and muscle should be altered to improve fitness was calculated, and those alterations are made.

FIG. 2F illustrates the gradient of fitness with respect to each patch is followed for nine iterations (cyan to purple traces).

FIG. 2G illustrates a tenth attempt resulting in an optimized design according to certain aspects of the present disclosure.

FIG. 2H illustrates the initial randomly-generated morphology (depicted in FIG. 1C), built using silicone (as described in FIGS. 1N and 1P-1Q). Four retroreflective spheres were also added to the top surface of the robot for passive motion tracking.

FIG. 2I illustrates the behavior of the initial randomly-generated design (blue line); and the behavior of the tenth design attempt according to certain methods presented here (purple line), when the two robots were exposed to pneumatic actuation.

FIG. 2J illustrates the tenth attempt, built using silicone (as described in FIGS. 1O-1Q), Four retroreflective spheres were added to the top surface of the robot for passive motion tracking.

FIG. 2K illustrates multiple first attempts according to certain aspects of the present disclosure. All 100 random initial conditions (first attempts) across 100 independent trials. Green CoM traces indicate that the initial designs primarily bounce up and down in place.

FIG. 3A depicts a graph illustrating following gradients with respect to both body shape and musculature, simultaneously (blue) resulted in significantly higher fitness (p<0.01) than optimizing body shape around a fixed musculature (orange) and optimizing musculature around a fixed body shape (green). Previous approaches to automate robot design were initialized with random samples of 10 or more designs; random samples of 10 designs yield little to no forward movement (purple).

FIG. 3B illustrates the gradient of fitness with respect to each patch is followed for nine iterations (cyan to purple traces). The musculature was held constant for this experiment, and only the body shape was permitted to change.

FIG. 3C illustrates the gradient of fitness with respect to each patch is followed for nine iterations (cyan to purple traces). The body shape was held constant for this experiment, and only the musculature was allowed to change.

FIG. 3D illustrates ten randomly generated design attempts (left), and the best design attempt among those ten (right).

FIG. 3E illustrates the average movement of internal voids and muscles across the 100 independent trials.

FIG. 3F illustrates the initial random design attempts (Attempt 1), and final design attempts (Attempt 10) achieved through the procedure disclosed here, for 5 of the 100 independent trials.

FIG. 3G illustrates multiple optimized designs from the 100 independent trials starting with the 100 different random initial conditions in FIG. 2K. Green CoM traces indicate all optimized designs were able to locomote forward with stable gaits. Morphological convergence to posterior-angled legs with anterior musculature can be observed across these 100 independent trials.

FIGS. 4A-4D illustrate application of the present algorithm extended to design problems that require efficient use of material (e.g. maximizing speed while minimizing surface area.

FIG. 4E illustrates application of the present algorithm extended to design problems that require object manipulation.

FIG. 4F illustrates application of the present algorithm extended to design problems that require transport.

FIG. 4G illustrates application of the present algorithm extended to design problems that require ejection.

FIGS. 4H and 4I illustrate application of the present algorithm beginning from an arbitrary, non-rectangular, initial boundary of triangles.

FIG. 4J illustrates application of the present algorithm beginning from an arbitrary, non-rectangular, initial boundary of a circle.

FIG. 4K illustrates application of the present algorithm beginning from an arbitrary, non-rectangular, initial boundary of a heptagram

FIG. 4L illustrates application of the present algorithm beginning from an arbitrary, non-rectangular, initial boundary of an enneagram (nine-sided star).

FIG. 4M illustrates a graph depicting the necessity of explicit voids. Without internal voids, fitness was greatly diminished (p<0.01).

FIG. 4N illustrates a graph depicting that shape change did not occur without internal voids.

FIG. 4O illustrates design attempts 1 through 10 showing minimal changes in both material properties and fitness.

FIGS. 4P-4S illustrate design attempts 20, 30, 40, and 50 showing minimal changes in both material properties and fitness.

FIG. 5A illustrates a quadratic interpolation was used between the edge (present material) and center of each void (empty space).

FIG. 5B illustrates a sharper linear interpolation between the edge (present material) and center of each void (empty space).

FIG. 5C illustrates that linear interpolation between the edge (present material) and the center of each void (empty space) rendered the body less differentiable than a quadratic interpolation.

FIG. 5D illustrates design attempts 1 through 10 of a robot optimized using a sharp linear interpolation.

FIG. 6A illustrates how morphology was constrained such that muscles are buildable as closed pneumatic bladders

FIG. 6B illustrates this constraint on the distribution of muscles within a robot body did not render the body less differentiable in preliminary experiments in terms of locomotion ability. In fact there seems to be a slight but significant improvement in fitness

FIG. 6C illustrates ten design attempts using the closed pneumatic bladder constraint starting from the same initial design parameters as in FIG. 1C.

FIG. 7 illustrates 24 of the 100 independent trials not already shown, the gradient of fitness with respect to each patch is followed for nine iterations (cyan to purple traces).

FIG. 8 illustrates 24 of the 100 independent trials not already shown, the gradient of fitness with respect to each patch is followed for nine iterations (cyan to purple traces).

FIG. 9 illustrates 24 of the 100 independent trials not already shown, the gradient of fitness with respect to each patch is followed for nine iterations (cyan to purple traces).

FIG. 10 illustrates 24 of the 100 independent trials not already shown, the gradient of fitness with respect to each patch is followed for nine iterations (cyan to purple traces).

FIG. 11 illustrates Table 1 depicting exemplarily design parameters.

FIG. 12 illustrates Table 2 depicting exemplarily mold parameters.

FIG. 13 illustrates hyperparameters that determine the distribution of initial radius for voids and muscles. (A) depicts the number of voids and muscles. (B) depicts interpolation within voids. (C) depicts interpolation within muscles. (D) depicts the threshold for particle removal within voids.

FIG. 14A illustrates initial void radius distributions from results of the hyperparameter sweep of FIG. 13.

FIG. 14B illustrates muscle radius distributions from results of the hyperparameter sweep of FIG. 13.

FIG. 14C illustrates number of voids from results of the hyperparameter sweep of FIG. 13.

FIG. 14D illustrates number of muscles from results of the hyperparameter sweep of FIG. 13.

FIG. 14E illustrates method of interpolation for voids (including linear, quadratic, and cubic) from results of the hyperparameter sweep of FIG. 13.

FIG. 14F illustrates method of interpolation for muscles (including linear, quadratic, and cubic) from results of the hyperparameter sweep of FIG. 13.

FIG. 14G illustrates thresholds for intra-void particle removal (including 10%, 20%, 40%) from results of the hyperparameter sweep of FIG. 13.

FIG. 14H illustrates comparing gradient descent (solid lines) to previous methods (dotted lines) with a budget of 10 design attempts from results of the hyperparameter sweep of FIG. 13.

FIG. 15 illustrates locally optimal robots (A)-(T). The most fit robot found by gradient descent in each of the 38 comparisons of FIGS. 14A-14H are illustrated. Because these comparisons aggregate results across overlapping sets of hyperparameter values, the best overall robot (T) was the best in 8 of the 38 comparisons. Other high performing robots also dominated multiple comparisons, yielding the 20 unique individuals plotted here. Gradient descent converged with high probability to local peaks in the non-convex search landscape: Distinct morphologies—different body shapes, numbers of limbs (3 to 5), and musculature (red) —capable of legged locomotion (green curves trace the robot's CoM during behavior). Designs are sorted from least (A) to most (T) muscle coverage.

FIG. 16 illustrates a table depicting hyperparameters used in certain experiments described in the present disclosure.

FIG. 17 is a block diagram illustrating an example system for generating a freeform design of a dynamic system by utilizing exemplarily a computing device, and in certain aspects, a service and a 3D printer.

FIG. 18 a diagram illustrating an exemplarily flow chart for generating a freeform design of a dynamic system, according to certain aspects of the disclosure.

FIG. 19 is a block diagram illustrating an example computer system with which the computing device, the service, and the 3D printer described herein can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The disclosed technology provides, in certain aspects, optimization of a robot's structure to exhibit a desired behavior, within seconds on a single consumer-grade computer, and the manufactured robot's retention of that behavior. As disclosed herein, in certain aspects, the disclosed technology can be combined with automated fabrication and scaled up to more challenging tasks, thereby providing near instantaneous design, manufacture, and deployment of unique and useful machines for, but not limited to, medical, environmental, vehicular, and space-based tasks.

It should be understood from the disclosure that the disclosed technology provides improvements over the current state of the art including, but not limited to, providing an entire design process of physical machines that is performed on the order of seconds on a single consumer-grade computer instead of being performed on the order of days with resource- and energy-intensive supercomputing. For example, the disclosed technology, which provides efficient design automation of physical machines, can revolutionize society's ability to rapidly and cost-effectively design new kinds of devices such as, but not limited to, unmanned aerial vehicles and autonomous robots, new kinds of synthetic biological constructs, such as organoids and biological machines, for example, as well as new kinds of materials, such as, but not limited to, meta- and architected-materials.

Autonomous robots pale in comparison to the complexity, adaptivity, and diversity of their living counterparts, animals, which emerged and radiated over billions of years of evolution. While human minds can invent new mobile machines much faster than natural selection, the forms and functions of these artifacts are tightly constrained by human imagination as well as economics: considerable labor, time, money, and resources are required to design, test, and deploy a new robot for a new task. As a result, existing mobile robots tend to share canonical body shapes, such as quadrupedal or humanoid, canonical size scales, such as centimeters or meters in length, and canonical materials, such as metals and plastics. Despite this standardization, no proof exists that such robot body plans are the best fit for the robot's intended niche, and useful mobile robots are not yet widely available. If scalable design and deployment of robots were to be achieved, and those robots could be rendered recyclable or biodegradable, robots of diverse size and shape could be deployed into millions of niches in natural and built environments, much like evolution and reproduction does in nature.

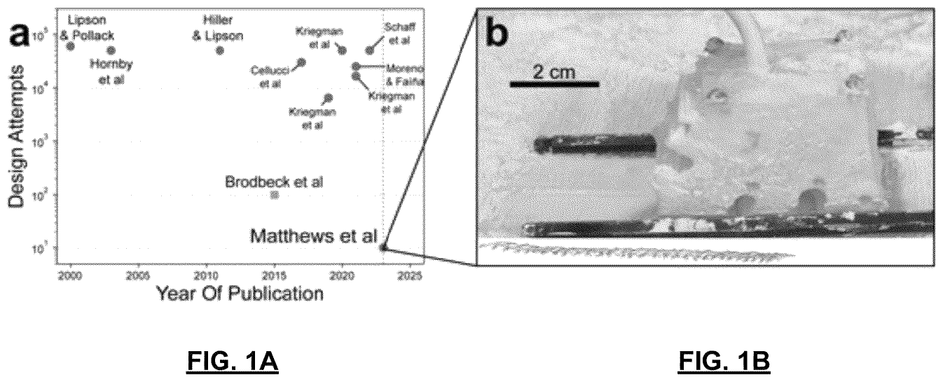

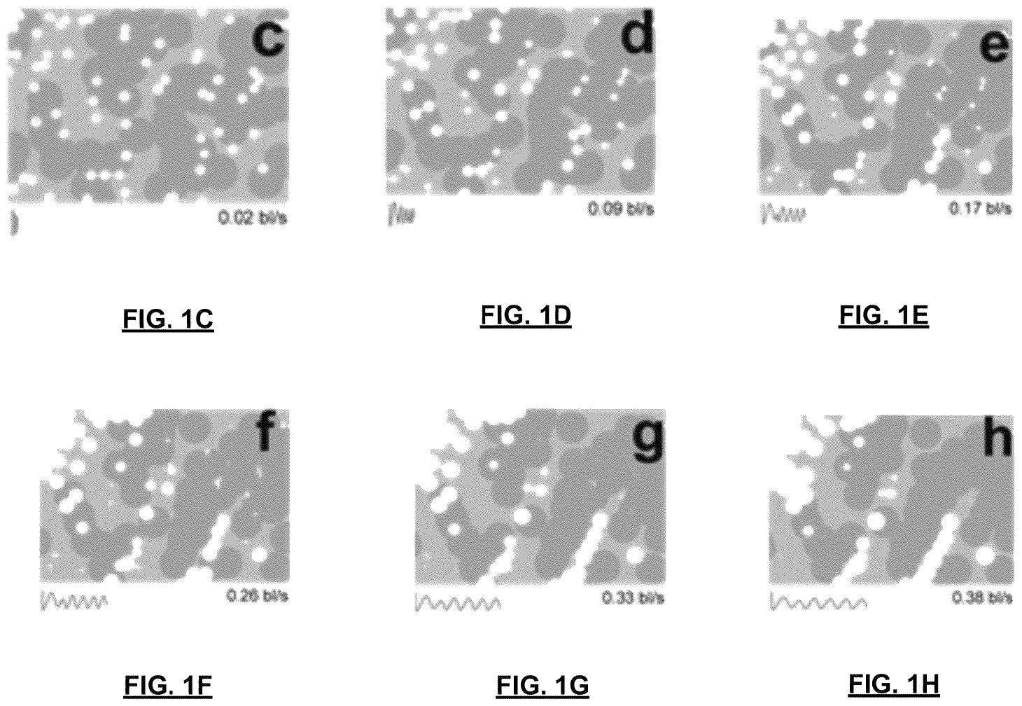

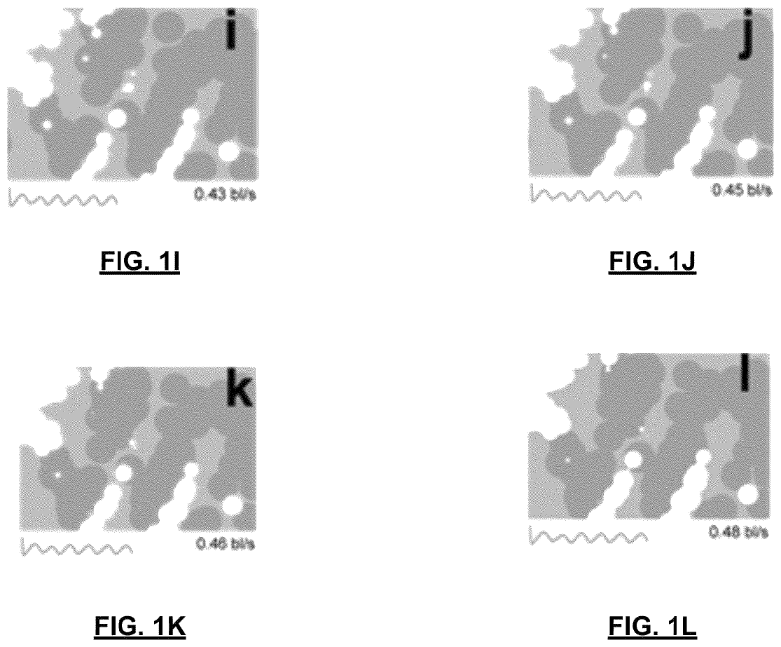

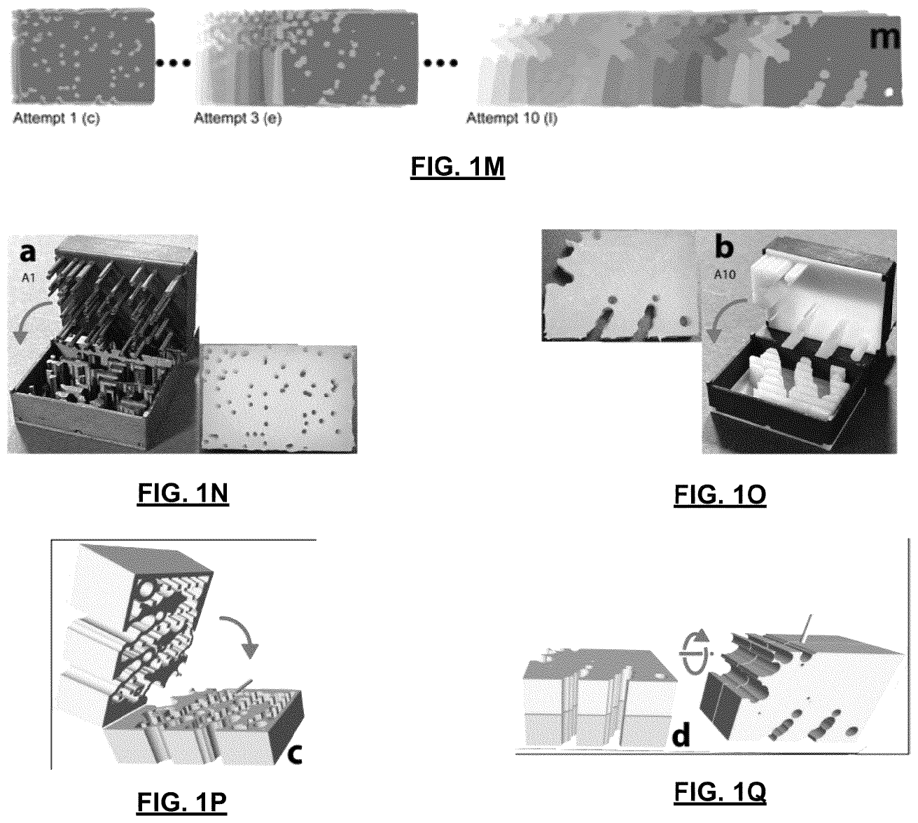

Thus, the disclosed technology provides an alternative, scalable approach for rapidly and cost-effectively designing new kinds of robot body plans with minimal prior assumption. For example, the disclosed technology can efficiently and automatically generated a custom robot in less than 30 seconds on a laptop computer (see FIGS. 1A-1M), requiring only 10 design attempts. This is orders of magnitude more efficient than all reported conventional robot design methods that utilized computer simulations and an order of magnitude fewer design attempts than a conventional method that forewent simulation. To date, the automatic design of physical robots has been achieved predominately through evolutionary algorithms: design variants evolve through random variation and selection. The trial-and-error nature of this process can lead to thousands or even millions of robots being evaluated in virtual environments before selecting one suitable for physical fabrication. Other evolutionary methods have evolved physical robots directly, without recourse to simulation, but these require hundreds of physical trials, again reducing efficiency. Evolutionary approaches are appealing for robot design as, like biological evolution, they often discover diverse and non-obvious body plans and behaviors; they cannot, however, guarantee discovery of locally optimal designs, and they are inefficient as the majority of effort is spent evaluating evolutionary dead ends. For these reasons, the disclosed technology improves upon such trial-and-error searches with gradient descent methods, which can efficiently follow paths through design space to optima.

Applying gradient-based optimization to robot design has been traditionally challenging because, like all motile organisms, there are complex feedback loops between the robot's body plan (e.g. its shape and distribution of motors) and its behavior. Determining which aspect of a robot's body plan caused some inefficiency in the robot's behavior, and how that body part could be changed to improve behavior, is a version of the credit assignment problem, a ubiquitous problem in artificial intelligence and, until now, unsolved for robot design.

The recent appearance of differentiable physical simulators has enabled gradient-based design of virtual robots: aspects of the robot's shape or material properties responsible for poor behavior can be identified and mitigated non-randomly to improve behavior. But these methods that produced them could not radically alter the robot's internal structure (musculature, mass distribution, and voids) or external structure, such as the addition of new limbs. Moreover, none of them were realized as physical robots. Some traditional gradient-based approaches are limited for optimizing only the orientation or length of a robot's limbs but the robot's overall structure (its distribution of limbs and motors) was presupposed and held fixed. In contrast, the present disclosed technology provides, for example, an algorithm that (i) simulates and then assesses the fitness of a virtual robot's behavior; (ii) identifies deficiencies in its overall shape, topology (number of voids), number and shape of limbs, mass distribution, musculature, and behavioral control; and (iii) changes all of them, simultaneously, so as to improve behavior in the next simulation. In certain aspects, the disclosed technology requires only 9 repetitions of this process (and thus only 10 simulations) to provide a design that, when built, retains the optimized function.

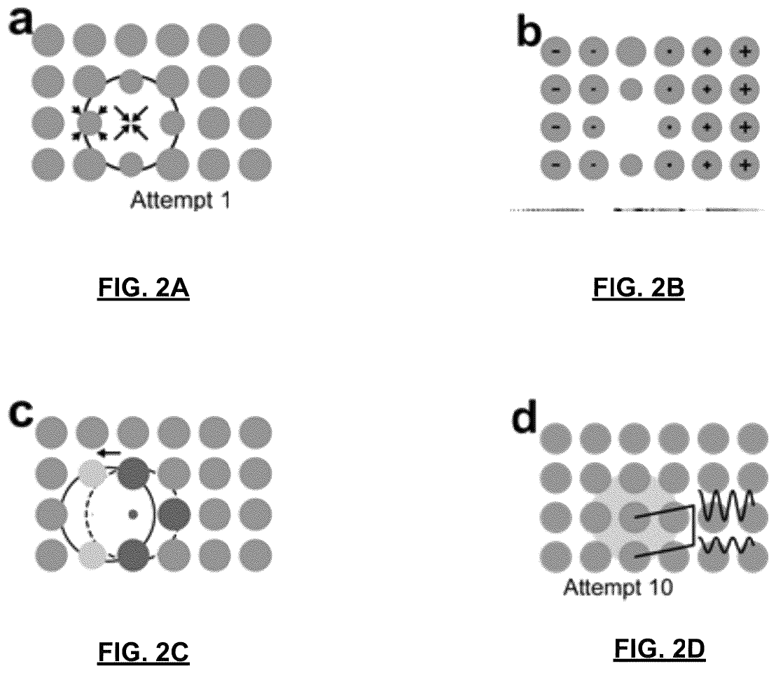

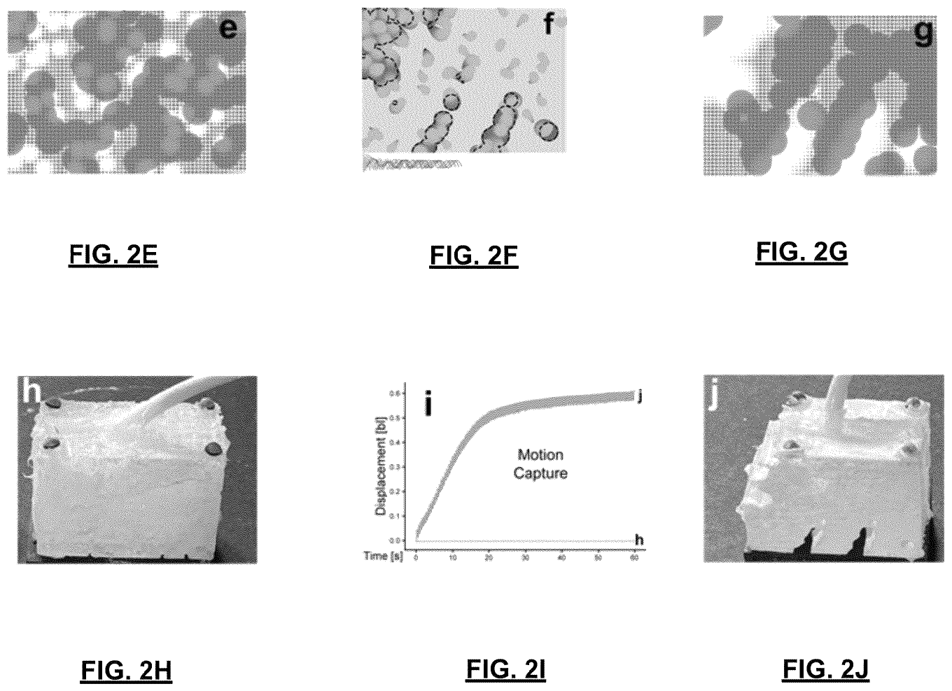

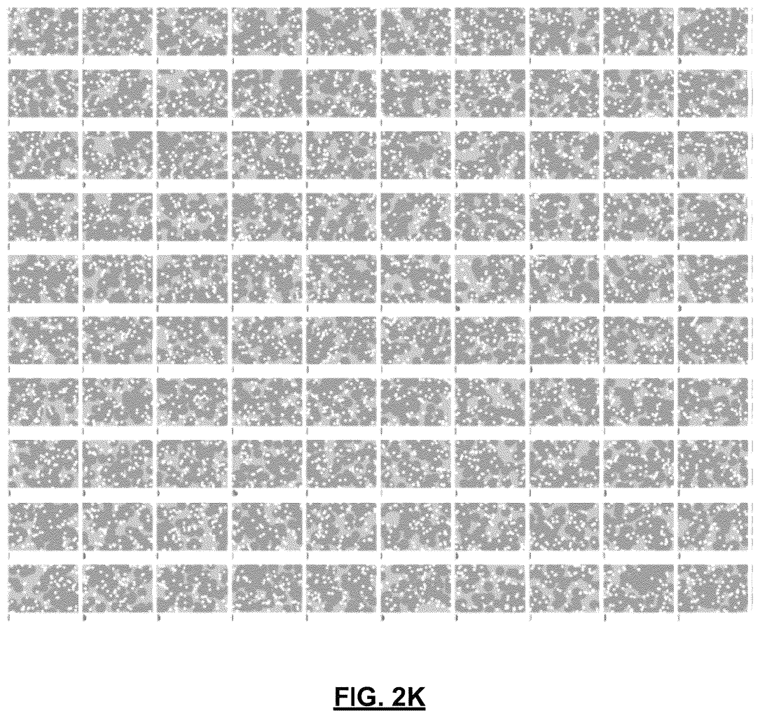

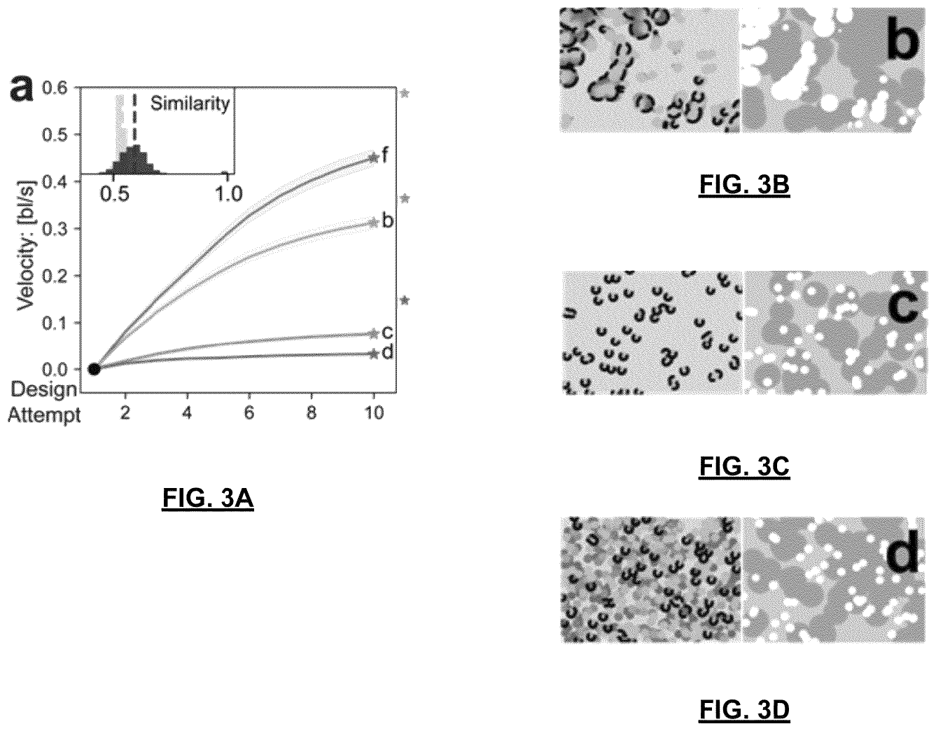

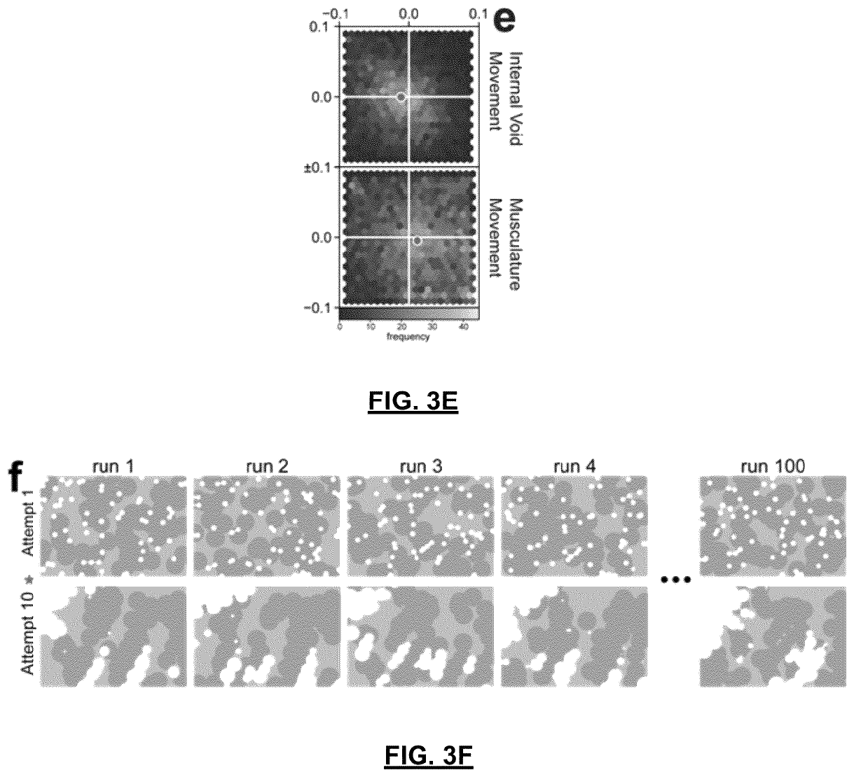

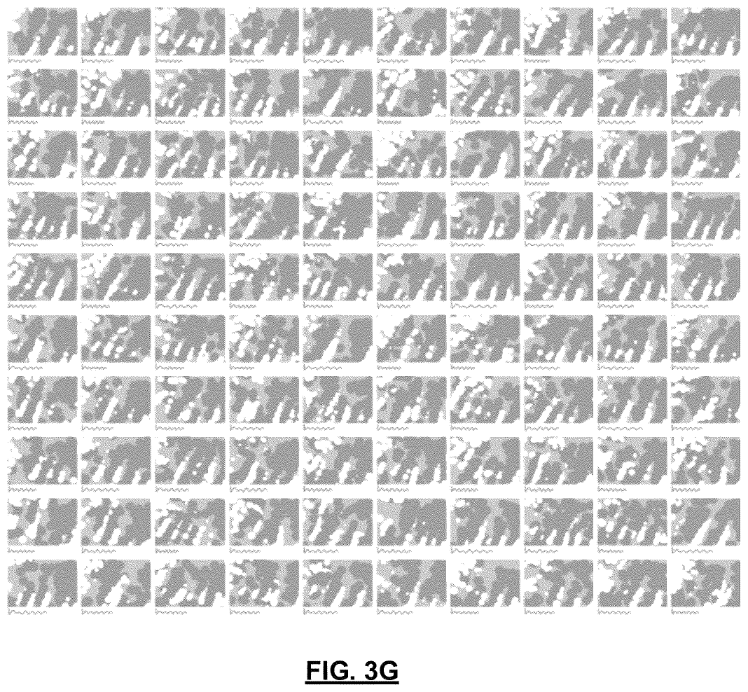

Terrestrial locomotion was selected as the target behavior as it is the defining function of higher animals. The fitness of a design was thus defined as the mean velocity of the simulated robot in the desired direction of travel. Starting from a randomly-generated body plan, fitness was increased from negligible movement to 0.5 body lengths per second (BL/s) (half of average human walking speed) with just nine additional design iterations (see FIGS. 1A-1M). This design (see FIGS. 1N-1Q) retains the behavior that was optimized in simulation (see FIGS. 2A-2J). To measure the method's consistency, the process is repeated starting from 99 different randomly-configured robots (see FIG. 2K) and observed increases from 0 to a mean of 0.45 BL/s over the 10 simulations, across these 100 trials (see FIGS. 3A-3F).

In an exemplarily process, several control experiments were performed to prove that the design process could and did make use of its freedom to change all aspects of the robot's shape, topology, and musculature to improve behavior, despite the complex interdependencies between them (see FIG. 3A). In the first control experiment, an initial random placement of muscles was generated and held fixed. Only the robot's shape and topology was then optimized (see FIG. 3B). In the second control experiment, muscle placement was optimized within a fixed, randomly-generated shape and topology (see FIG. 3C). The first and second control experiments yielded simulated robots with significantly lower fitness than the final robots from the original experiment [0.31 (99% CI 0.30 to 0.33) and 0.08 (99% CI 0.07 to 0.08) BL/s, respectively, compared to 0.45 (99% CI 0.43 to 0.47) BL/s], thus the body plan and musculature were consistently co-optimized. This demonstrates that AI methods must be allowed to simultaneously track and correct inefficiencies across many different aspects of a robot's physical structure to achieve efficient design of motile behaviors. The demonstrated interdependency between robot shape, musculature, and movement also shows that robot design optimization is not reducible to the more commonly explored problem of topology optimization for static structures.

The algorithm, according to certain aspects of the disclosed technology, dominates state-of-the-art automated robot design, which is currently accomplished with gradient-free, evolutionary algorithms. Since all such conventional methods (see FIG. 1A) start with populations of more than 10 randomly-generated robots, they all reduce to random search when assigned a design budget of 10. Random search results are found in little to no appreciable forward movement (see FIG. 3D) under these conditions.

The disclosed algorithm can discover crawling or peristaltic motion. For example, the disclosed algorithm consistently rediscovered the third (and most efficient) known form of terrestrial movement: legged locomotion (see FIG. 3G). The disclosed algorithm did so by moving or merging internal voids to create gaps between prospective limbs (see FIG. 3E; FIGS. 7-10), and patterning muscles along each of their anterior edges to coordinate their movement (see FIG. 3E). These changes consistently resulted in two or three posterior-angled appendages (see FIG. 3F;

FIGS. 7-10).

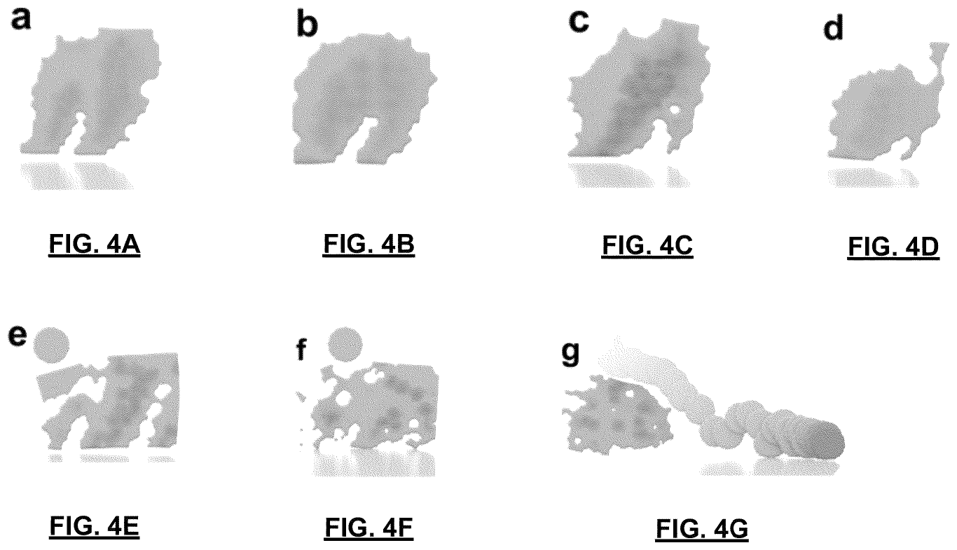

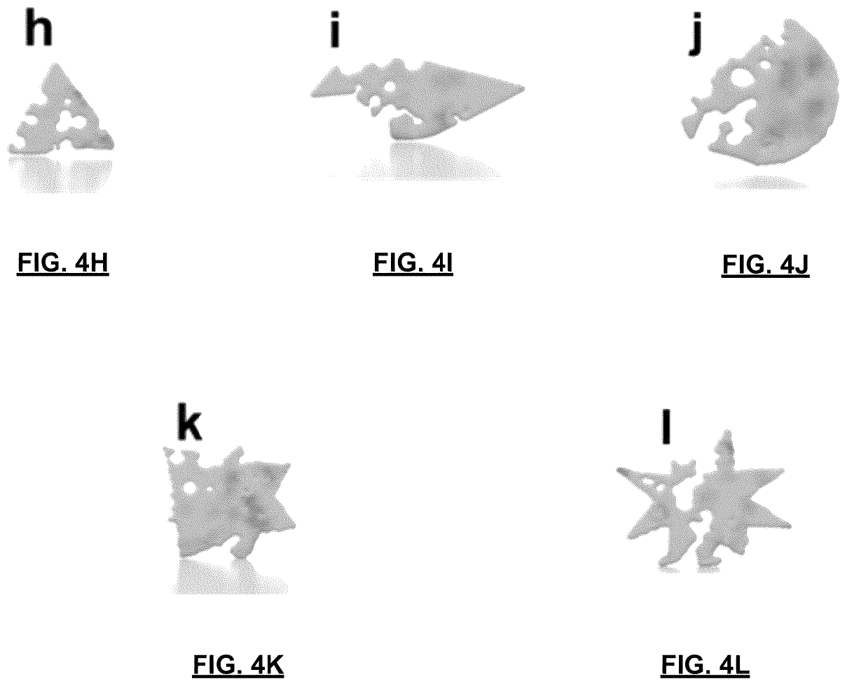

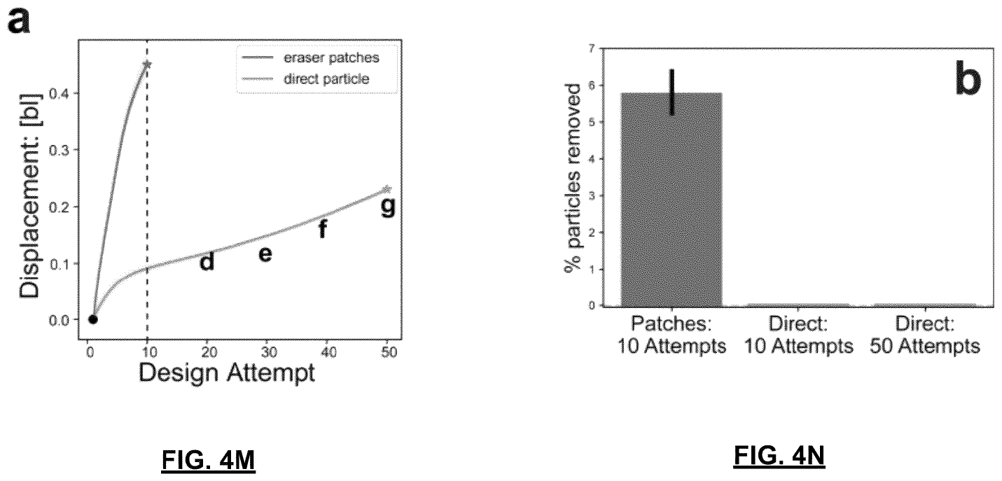

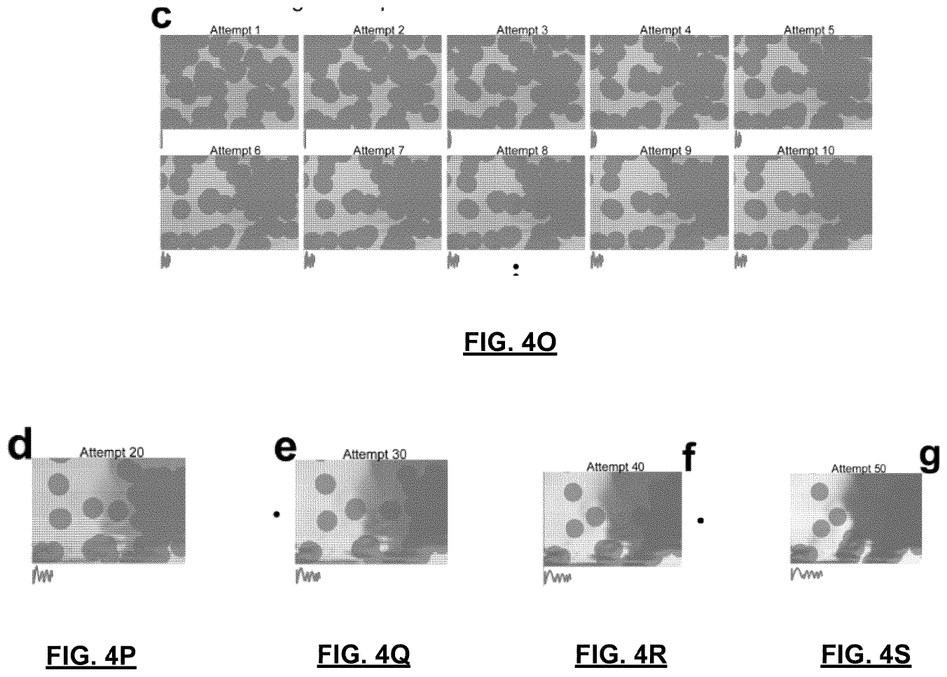

FIGS. 4A-4L illustrate the disclosed approach's generality: robots can be automatically and efficiently designed under other constraints, such as conservation of materials (see FIG. 4A); for different tasks, such as object manipulation (see FIG. 4B), object transport (see FIG. 4C), and object ejection (see FIG. 4D); and starting from different, arbitrary, non-rectangular initial shapes (see FIGS. 4E-4I). Within these conditions, very different kinds of robot forms and functions emerged.

While these results demonstrate efficient design automation for a mobile robot, other appropriate designs are well within the scope of the present disclosure. For instance, the computational efficiency of the physics model can be optimized to run faster than realtime and gradient computations can be optimized to be faster as well. Also, in other aspects, the disclosed algorithm may be allowed to alter the robot (moving and resizing internal voids or muscles) and may extend to other kinds of materials (e.g. metals) and motors (e.g. rotary). It is also within the scope of the present disclosure to provide algorithms that are better at discovering and following gradients, and that generate robots from compressed representations rather than directly rearranging their components. Finally, aspects of the physical robot's design were improved against just one feature (speed) of one behavior (locomotion); in nature, diverse selection pressures simultaneously act on species. Thus, the disclosed technology can include alterations that improve multiple features (reliability, safety, and energy efficiency) of multiple behaviors (object manipulation, collective behavior) through multi-objective optimization and optimizing the objective functions themselves. The significant efficiency gains, discussed above, compared to prior work illustrates that the disclosed technology can be more easily scaled to realize physical robots with more complex morphologies and behaviors (see FIG. 4A-4L).

In an exemplarily method of the present disclosure, the design pipeline starts with a randomly-configured simulated robot and optimizes its structure over nine design iterations. The final robot design is then built and its physical behavior is assessed.

With respect to initial conditions, sixty-four voids and 64 muscle patches are placed randomly within a 20 cm-by-14 cm rectangular body. The initial location of each void is drawn from a uniform random distribution; the radius of each void is sampled from a gaussian distribution with a mean of 0.91 cm and a standard deviation equal to the square of the mean. This radius ensures that 64 nonoverlapping voids within the body results in the removal of 60% of the body on average. The initial location of each muscle patch is drawn from a uniform random distribution. The radius of each muscle patch is fixed at 1.2 cm. This radius allows 64 nonoverlapping muscle patches to just cover the entire robot's body with musculature, in case such a distribution, or one similar to it, is useful.

The robot is modeled, for example, as a collection of elastic particles (see FIGS. 2A-2J) using the material point method (MPM), a hybrid Eulerian-Lagrangian model. Directly optimizing the parameters of individual particles, without explicit voids, did not yield any changes in the robot's shape and resulted in significantly lower fitness (see FIGS. 4M-4S).

Each design iteration comprises a forward and backward pass. During the forward pass, the robot is simulated using a differentiable simulator. At each time step of the simulation, internal forces from within the robot's body (its muscles and elastic deformation) and external forces from the environment (gravity, friction, collisions) are computed and the acceleration of each particle is updated. At the end of the evaluation period, a fitness score is automatically assigned to grade the robot's locomotive ability: the mean forward velocity of each particle during behavior, summed across particles. Since each function in this process is differentiable, the entire process, including the fitness computation, is differentiable.

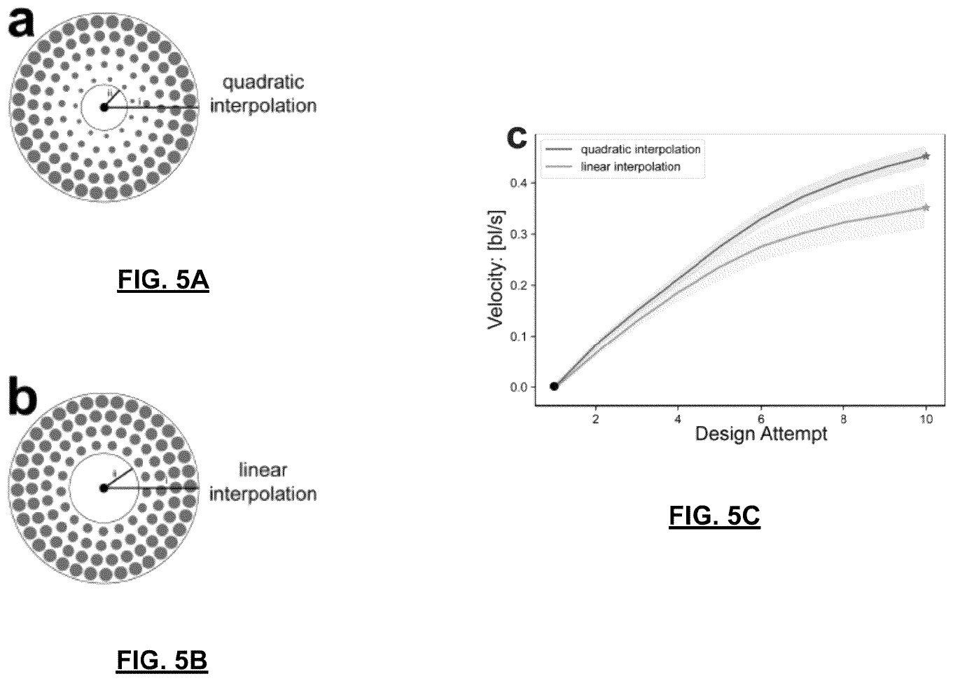

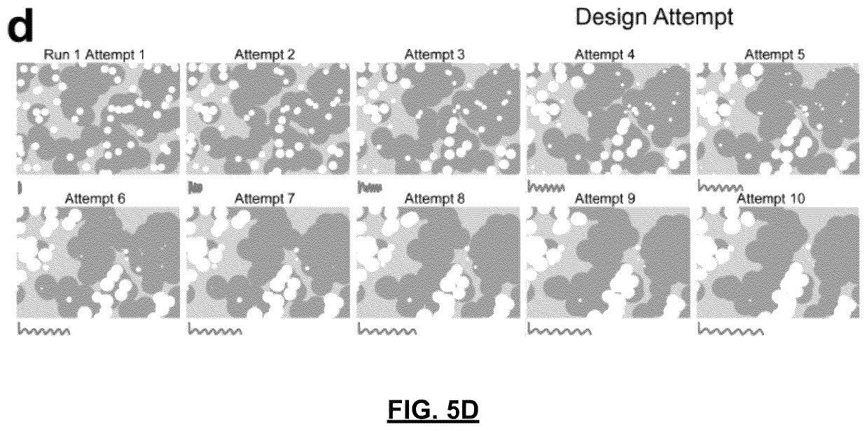

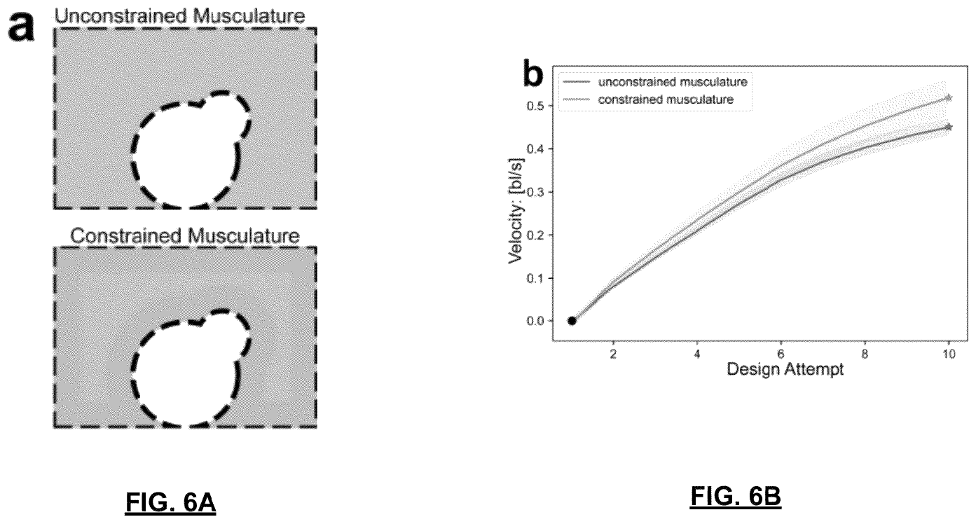

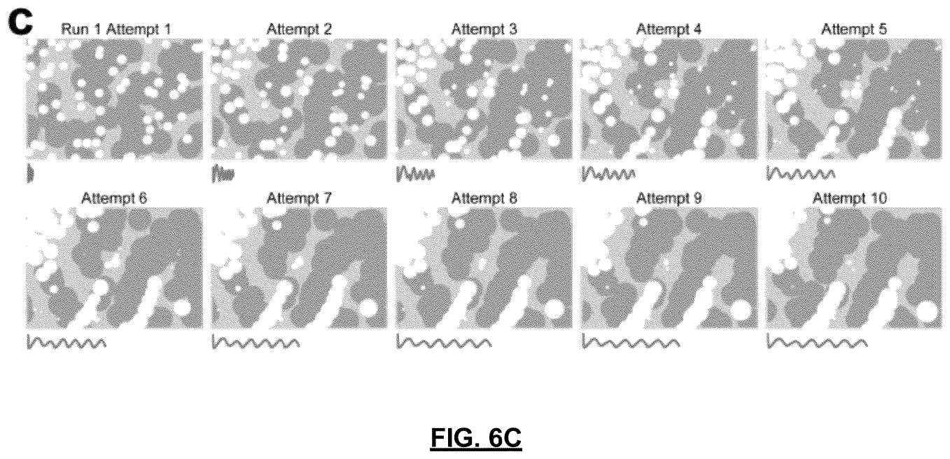

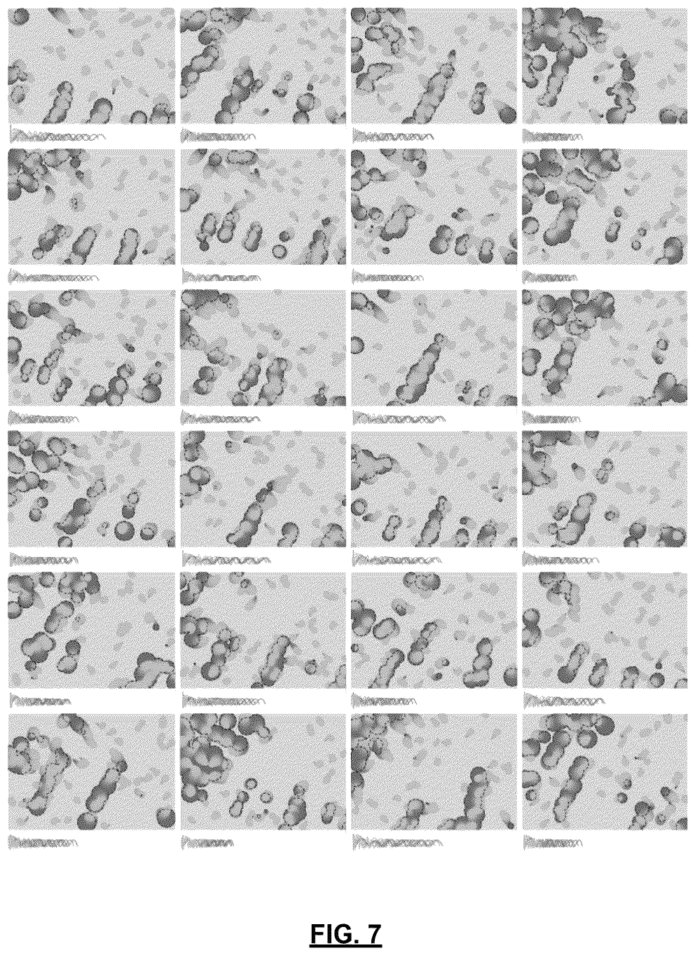

During the backward pass, fitness affects the location and radius of each void (Eqs. 1 and 2 below) and the location of each muscle (Eqs. 2 and 4 below). These functions are differentiable because they smoothly (quadratically) interpolate particle properties along the radius of an internal void or muscle, avoiding large discrete step functions at boundaries. More specifically, particle mass and elasticity decrease within a void, from edge to center, before entirely removing particles at their core (see FIGS. 2C and 5A-5D). Muscles similarly interpolate volumetric actuation, increasing actuation amplitude from edge to center. A steeper (linear) interpolation was also tested for voids, but this resulted in designs with significantly lower fitness (see FIGS. 5A-5D). Both of the interpolation functions that were explored (quadratic and linear) introduced a gradient of decreasing mass and elasticity within a void (see FIGS. 5A and 5B), but they also completely removed particles, below some threshold (see Table 1 in FIG. 11). When a void is moved or decreased in radius, particles are gradually added back into the robot's body (discussed further below). Both musculature and voids were allowed to move off, and back on to, the body.

The physical robot is built by casting a silicone body with pneumatically actuated muscles (discussed further below). To do so, two three-part molds of the design are 3D printed (see FIGS. 1N-1Q). Each mold is then filled with silicone and allowed to cure to form one half of the robot's body. The two halves (left and right) of the design are sealed together with additional silicone and four retroreflective spheres are glued onto the top four corners to facilitate motion capture. Musculature is instantiated as a hollow bladder within the robot's body and is actuated pneumatically through a dorsal air inlet.

The robot's body and its environment are coated in cornstarch to match the friction parameters resident in the simulator. To compensate for asymmetries along the sagittal seam between the robot's two sealed parts, the robot is placed between two alignment rails (see FIG. 1B). This helps ensure the robot's movement stays along a straight, rather than curved, path.

The muscles are then actuated to create movement and allow for the possibility of locomotion in the desired direction. To do so, the robot's air inlet is connected to a proportional pressure control valve that generates a square wave with an amplitude of 300 mBar, a wavelength of 500 ms, and a duty cycle of 50%. The robot is actuated for 1 minute and its behavior is recorded with passive optical motion capture. After each behavior evaluation, the environment is reset: the robot is returned to its starting position, additional cornstarch is added to the terrain and raked to have a thin grooved surface. Six behavioral trajectories of the optimized robot are collected and five are collected of the unoptimized robot. The optimized design moved significantly further on average than the unoptimized design (p<0.01; Mann-Whitney U).

Ninety-nine additional independent simulations were conducted in silico to better understand how (if at all) different random initial conditions (see FIG. 2K) affected the optimized body plans (see FIG. 3G), the design space (see FIGS. 4M-4S), its sensitivity to hyperparameters (see FIGS. 5A-5D), how details of a particular manufacturing process can be incorporated as design constraints (see FIGS. 6A-6C), and the paths gradient descent followed through morphospace (see FIGS. 7-10).

In an exemplarily simulation, each design is modeled by a 64-by-44 partially-filled uniform grid of present/absent elastic particles (at most 2816 particles; 20-by-14 cm) and simulated using the Material Point Method (MPM) for T=1024 time steps with step size of 0.001 sec for a total evaluation period of 1.024 simulated seconds. One second of simulation time can be computed faster or slower than realtime, depending on the step size. Smaller step sizes are more accurate than larger step sizes but require more steps (and thus more wallclock time) to simulate 1 second. The number of time steps is also constrained by memory and the accumulation of floating point rounding errors. Here, for example, material properties of simulation are chosen to allow for six actuation cycles to occur during the 1024 time steps, a single second of simulation time.

In certain aspects, at each time step, viscous damping is applied to each particle, the actuation state of each particle is calculated, and a vertical expansion or contraction force is generated.

In the exemplarily main experiment, which culminated in the fabrication and testing of the automatically-designed physical robot (see FIGS. 1N-1Q and 3G), and was repeated 99 times from different random initial configurations (see FIG. 2K), a design consists of at most 64 internal voids, which remove contiguous circular regions of particles from the body grid, and at most 64 muscles, which expand and contract in volume by increasing and decreasing the distance between their constituent particles. The 64 voids are moved and resized by optimization; the 64 muscles are moved by optimization but have fixed size (radius of actuation, r_{c}=1.26 cm). Voids and muscles can be removed based on their location (off the grid); voids can also be removed by reducing their radius to 0. Unless otherwise noted, we will assume the hyperparameters used by the main experiment.

The mass and elasticity of each particle was based on its position relative to nearby voids. For each particle, φ∈Φ, and void, k ∈K, the euclidean distance, d_{φ,k}, was calculated between every particle-void pair, {φ, k}, and divided by the void's current radius, rₖ, yielding a normalized distance, d_{φ,k}*=min(1, d_{φ,k}/rₖ). The mass of particle φ was then computed as:

$${m}_{φ} = {[ {min}_{k ∈ K} ( {d}_{φ , k}^{*} ) ]}^{2} \times 1 kg , \qquad ( 1 )$$

the square of the minimum normalized distance from the particle to every void in the body. Particles toward the center of a void, with a mass less than λ=0.1 kg, were removed from simulation. The particle's elasticity, E_{φ}, was set to be proportional to its mass: E_{φ}=m_{φ}×20 Pa.

Simulated muscles undergo six actuation cycles during the 1024 timesteps of simulation. At each time step, viscous damping is applied to each particle, the actuation state of each particle is calculated, and a vertical expansion or contraction force is generated. The actuation amplitude of each particle is based on its position relative to nearby muscles. For every muscle, c ∈ C, the euclidean distance, d_{φ,c}, between each particle-muscle pair, {φ,c}, was calculated and normalized as in Eq. 1. The actuation amplitude of particle φ was then computed as:

$${A}_{φ} = {( 1 - ( {d}_{φ , c}^{*} \times \sqrt{0.1} ) )}^{2} , \qquad ( 2 )$$

a quadratic interpolation with a minimum amplitude of 0.45 at the border of each muscle patch. Particles outside of muscle patches, with d_{φ,c}*=1, were assigned zero actuation amplitude.

The actuation state of each particle at simulation time t was:

$${ω}_{φ , t} = 4 \times {m}_{φ} \times tanh ( {A}_{φ} \times sin ( t \times d t \times f ) ) , \qquad ( 3 )$$

the hyperbolic tangent of a sinusoidal function with amplitude A_{φ} and frequency ƒ=6 Hz, normalized by the particle's mass and relative to a global actuation strength of 4 Pa per particle. Normalizing by mass helps avoid numerical instabilities caused by tearing, which can occur from high particle acceleration due to low mass and high force.

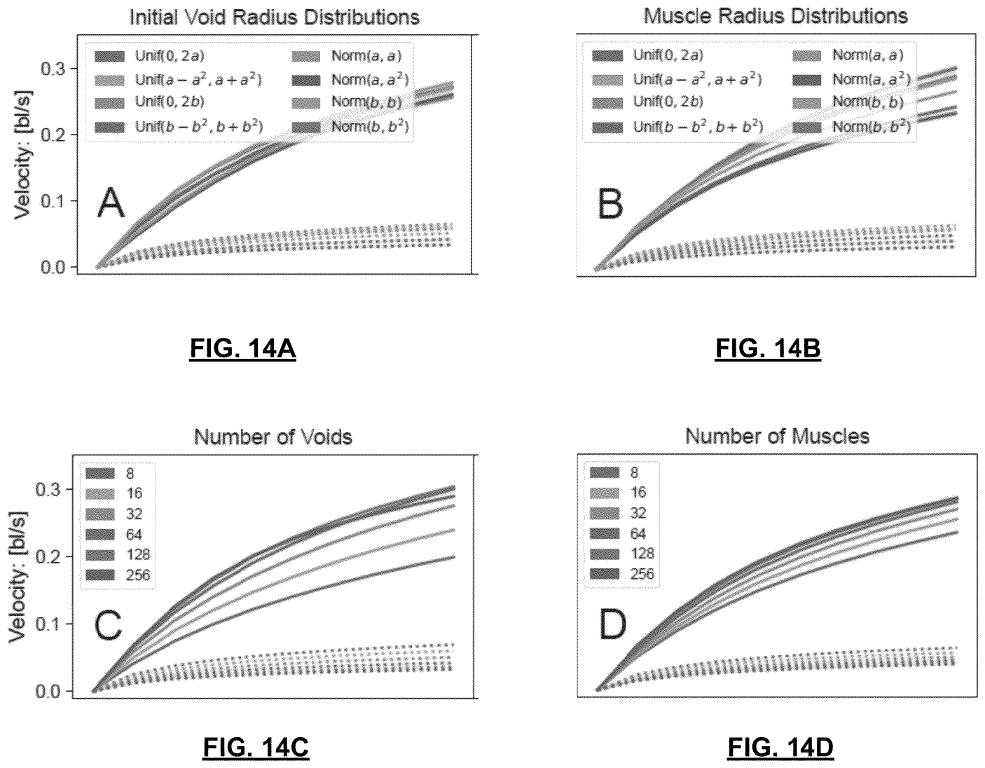

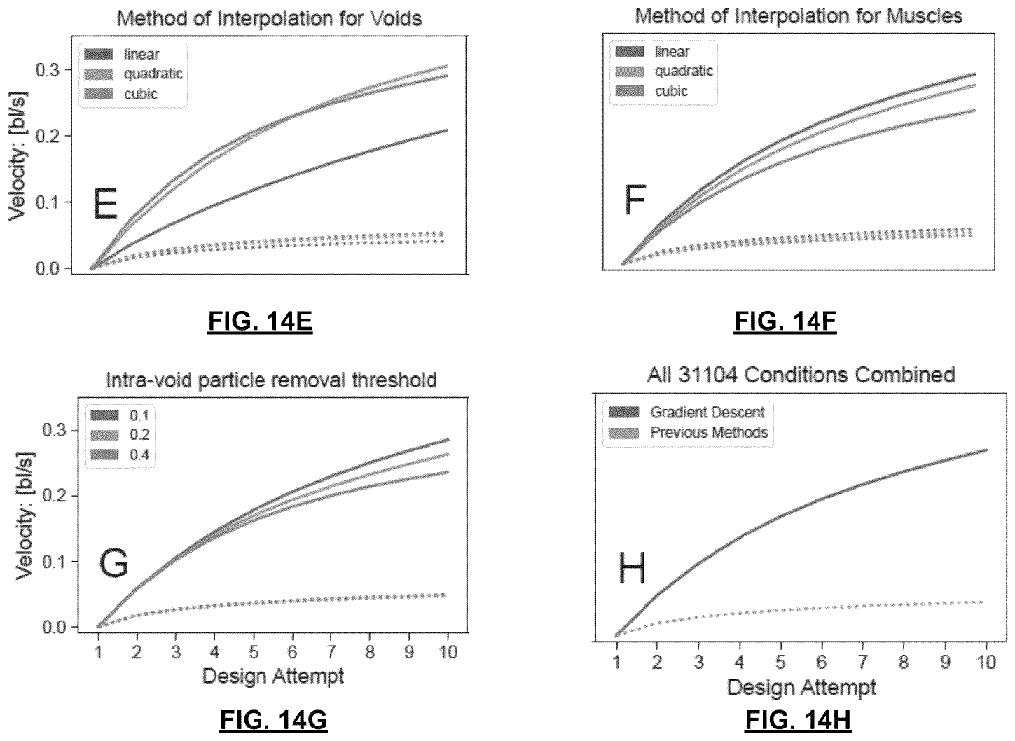

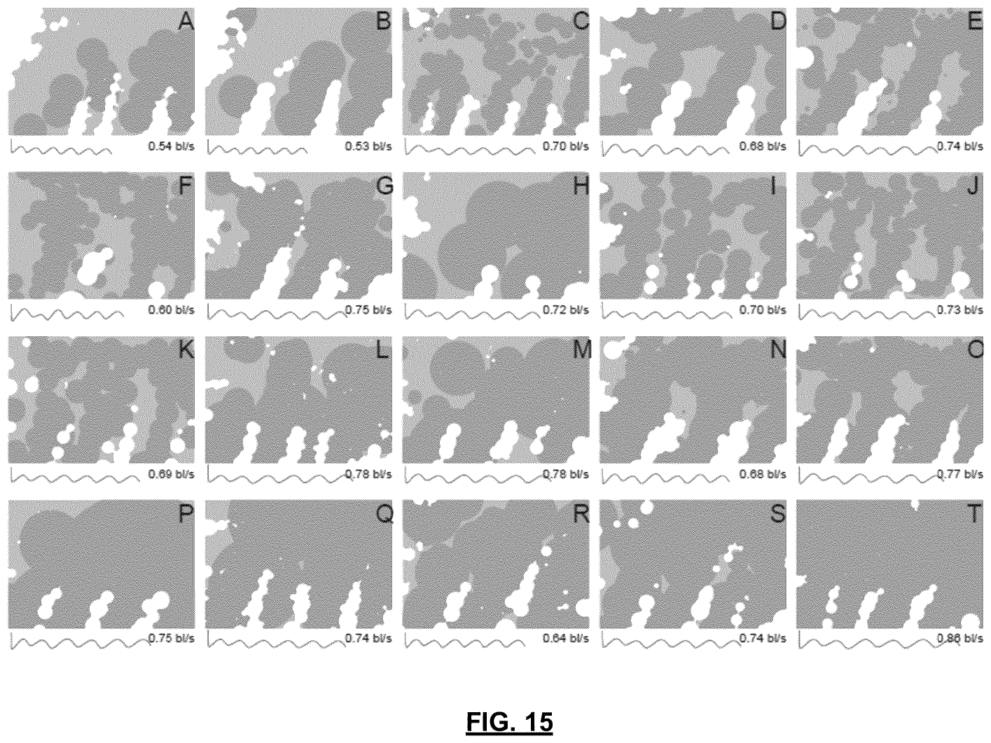

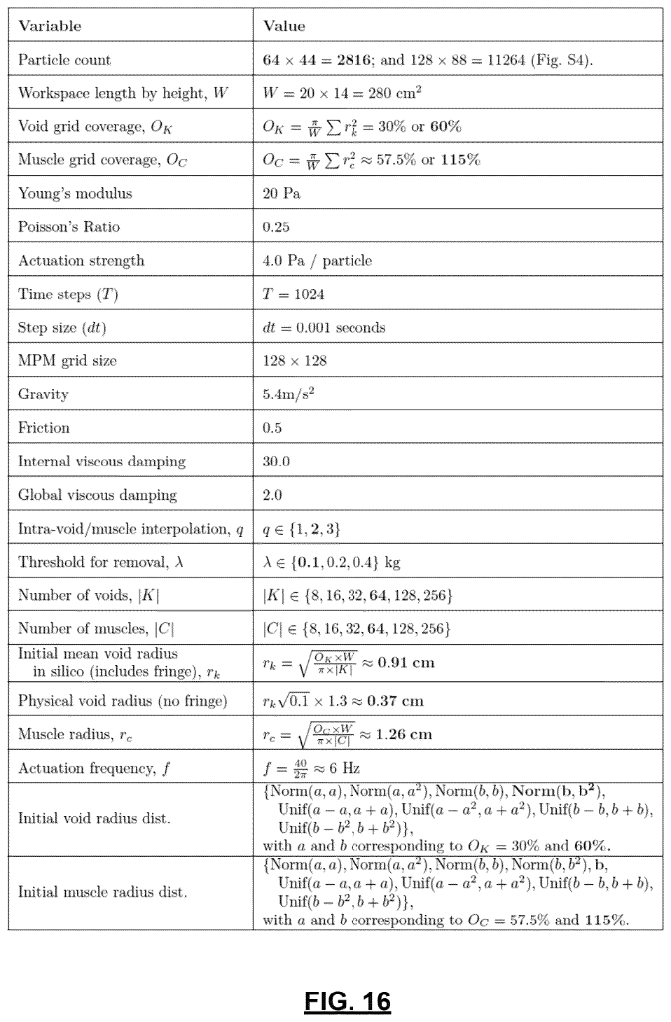

Other void (see FIG. 14A) and muscle (see FIG. 14B) radii, other numbers of voids (see FIG. 14C) and muscles (see FIG. 14D), other interpolation functions for the particles inside voids (see FIG. 14E) and muscles (see FIG. 14F), and other thresholds for particle removal within voids (see FIG. 14G) were explored in a subsequent hyperparameter sweep (see FIGS. 13-15) and detailed in the table illustrated in FIG. 16.

Initialization. Optimization begins with a randomly generated design. Random designs comprised 64 internal voids and 64 muscles, randomly sized and positioned along the robot's body. The position of each patch was selected from a uniform distribution across the robot's body (20-by −14 cm). The radius of each muscle was fixed at r_{c}=1.26 cm. The initial radius of each void was drawn from a normal distribution with mean μ=0.046×20 cm and standard deviation of 0.046²×20=0.042 cm. This removes 60% of the 2816 particles, on average, under the assumption that the voids are non-overlapping. In other words, if the 64 sampled voids are arranged side-by-side on a grid, a combined area (their “grid coverage”; O_{K}) will be approximately O_{K}=60% of the robot's body area, on average. Several other distributions of initial radius (see table in FIG. 16) were explored in the hyperparameter sweep (FIGS. 14A, 14B).

Fitness. The fitness of a design is taken to be the mean forward velocity of the robot, which is calculated as the mean position of all of the particles at the final time step subtracted by the mean position of all of the particles at the first time step.

Loss. Gradient descent toolkits typically default to minimizing an error function rather than maximizing a fitness function. For this reason, the loss function is defined as −1* average forward velocity. That is, negative fitness (locomotive deficiency). Gradient based optimization methods have historically used the metaphor of a ball on a hill: descending a slope (of error or loss) within a landscape defined by some objective function. Evolutionary biology has instead used the metaphor of hill climbing: evolution as an active force that ascends slopes within a fitness landscape. These two metaphors, of maximizing fitness (negative error) and minimizing error (negative fitness), are functionally isomorphic.

Backpropagation. Backpropagation is performed through the differentiable simulator, yielding gradients of loss (negative fitness) with respect to initial particle parameters. Initial attempts to directly optimize these initial particle parameters did not yield any changes in topology (see FIG. 4M-4S). Internal voids, if they possess non-zero radius, explicitly remove particles, thus enabling topology optimization. Gradients are thus backpropagated one step further, from the particle parameters through the patch based design function (Eqs. 1-4), yielding gradients of loss with respect to the patch parameters (positions and sizes of voids, and positions of muscles).

Gradient descent. Gradient descent using the Adam optimizer with a learning rate of 0.01 is used to optimize the design parameters. Gradients from simulation are used to perform nine gradient descent steps, which, including the initial randomly generated design, was 10 design attempts.

In exemplarily physical experiments:

Simulation-to-reality transfer. The physical robot (5 cm wide) was manufactured as a 4:1 scale model of its simulated counterpart (20 cm wide), and driven by pneumatic actuation. To do so, the soft fringe of quadratically decreasing mass/elasticity inside each simulated void (Eq. 1) was sharpened with a binary step function describing where silicone will and will not be present. The particles closest to the fully-removed core of each simulated void, which have very low stiffness and minimally contributed to robot's structure, were removed before building the design. More specifically, the physical voids fully remove material in a radius that is 1.3 times larger than the fully removed portion of the simulated voids. Outside this radius, material is fully present. The physical void radius is also used in the figures when displaying void area rather than their influence on each particle.

In simulation, muscles expanded along the y-axis and were permitted to “hang off the body” along the exterior surface of the design. When manufacturing the robot as a silicone body with hollow bladders, actuated regions within 3 mm of the edge of the body were filled with passive material (FIG. 6A). Incorporating this post-processing step as a optimization constraint results in the very same locally-optimal design when optimizing from the same randomly generated initial design.

Physical muscles were connected together with small cutouts, and horizontal stiffeners were added to the actuation bladders to limit the horizontal component of expansion when pressure is applied. Finally, a pneumatic port was also added to the center of the top of the robot. The robot was split along the sagittal plane, and a three-part mold was generated for each half (FIGS. 1N-1Q). The mold (six parts in total) was then printed using a Markforged X7 3D printer with Onyx filament.

Casting the robot. Each mold is covered in a mold release. The bottom and middle parts of the mold are assembled (see FIGS. 1N and 1O). Smooth-On Dragon Skin 10 Fast is mixed and degassed in a vacuum chamber for 7 minutes. Each mold is filled with silicone, and the third mold piece (lid) is inserted. A heavy weight is then placed on top of the lid to hold it in place during the 75 minute curing period. The cured robot halves are removed from the molds, and silicone flashing is trimmed off with scissors and a scalpel. Silicone rubber tubing is glued into one of the robot halves with Sil-Poxy and allowed to cure for 12 minutes. The two robot halves are then siliconed together with another batch of degassed silicone and allowed to cure for another 75 minutes. Four retroreflective balls are glued onto the top four corners of each robot using Sil-Poxy.

Evaluation. Cornstarch (Argo) was placed on top of a sheet of plastic and raked to have a thin grooved surface. Two alignment rails were added to the surface to simplify the comparison of the simulated robot (which can only move in a straight line) and the physical robot (which has a slightly curved gait due to asymmetries along its sagittal seam where its two halves meet). The robot was placed between the two alignment rails and connected to a Festo proportional pressure control valve (PPM-6TA-L-1-F-0L2H-S1) that generated a square wave with an amplitude of 300 mBar, a wavelength of 500 ms, and a duty cycle of 50%. The robot was actuated for 1 min and its behavior was captured using a motion capture system (OptiTrack). After evaluating the robot's behavior, the environment was reset. Six behavioral trajectories of the optimized robot (Attempt 10) were collected and five were collected of the unoptimized robot (randomly generated; Attempt 1). The optimized design moved significantly further on average (winning design vs randomly generated robot: MannWhitneyU test; p<0.01).

In exemplarily supplemental approaches:

Additional experiments were conducted in silico to promote the efficient use of building material, round sharp edges and corners on the body, re-place deactivated voids/muscles, include agonistic and antagonistic musculature, achieve other behaviors besides locomotion, enable interactive design from user-defined initial morphologies, incorporate details of the manufacturing process as optimization constraints instead of post-processing steps, directly optimize particles instead of explicit voids and muscle patches, and explore other methods of interpolation within voids and muscles, other thresholds for particle removal within voids other initial distributions of void and muscle radius, as well as different numbers of voids and muscles. Each experiment (each condition) was repeated across several independent trials; each repeated trial starts from a unique random initial configuration (a unique random seed).

### Eroding Unnecessary Body Parts (See FIGS. 4A-4B,4E-4G).

To promote efficient use of building materials we combined the gradients from simulation with a global material erosion term, which encourages the removal of unnecessary body parts by applying a pressure for a robot's total mass to reach some target amount. More specifically, the gradient of fitness (loss; l) with respect to particle mass (m_{φ}) was computed as a linear combination of simulation loss (lₛᵢₘ) and the erosion term:

$$\frac{\partial ℓ}{\partial {m}_{φ}} = \frac{\partial {ℓ}_{s i m}}{\partial {m}_{φ}} + α \times [ {max}_{φ ∈ Φ} ( \frac{\partial {ℓ}_{s i m}}{\partial {m}_{φ}} ) - {min}_{φ ∈ Φ} ( \frac{\partial {ℓ}_{s i m}}{\partial {m}_{φ}} ) ] \times tanh ( β \times ( {\overline{m}}_{φ} - {m}^{*} ) ) , \qquad ( 4 )$$

where m̅φ is the average particle mass (including removed particles with zero mass); coefficients α=0.01 and β=10; and a target average mass m*∈{0.25,0.5,0.75}. The hyperbolic tangent function is an S-shaped curve that caps the material erosion gradients at 1, and the constant β compresses the curve to be steeper and more rapidly approach 1. Thus, with α=0.01, the magnitude of the erosion term is scaled to 1% of the range of particle gradients from simulation. As a result, gradient descent will tend only to remove (or add) material in ways that minimally impact the behavior of the robot. Pressure to add material occurs if the robot's mass falls below the target; however, the target mass was chosen to be low enough that this was not observed.

Minimizing rotational moment (see FIGS. 4A-4B,4F). In addition to augmenting the gradients through a material erosion term, a second augmentation term to minimize rotational moment of inertia was also introduced. This term helps to keep the robots compact, especially when used in combination with other terms which encourage removal of material writ large (see FIGS. 4A-4B, 4F). To do so we first computed the robot's center of mass, Φ_{x,y}, as well as the euclidean distances between Φ_{x,y} and each particle φ, which we denote ν_{φ}. The rotational moment was then computed as:

$${v}_{φ} = D ( φ , {Φ}_{x , y} ) \qquad ( 5 )$$

$$h ( {v}_{φ} ) = ( \begin{matrix}{v}_{φ} & if {v}_{φ} < 0.25 \\ 2 {v}_{φ} - 0.25 & otherwise\end{matrix} \qquad ( 6 )$$

$${ℓ}_{I} = {\sum }_{φ ∈ Φ} ( {m}_{φ} \times h ( {v}_{φ} ) ) . \qquad ( 7 )$$

This loss was then backpropagated through to the mass of each particle and linearly combined with the particle gradients from simulation:

$$\frac{\partial ℓ}{\partial {m}_{φ}} = \frac{\partial {ℓ}_{s i m}}{\partial {m}_{φ}} + γ \frac{{ℓ}_{I}}{\partial {m}_{φ}} , \qquad ( 8 )$$

where γ∈ {0.0001,0.0005,0.001}.

De-brickifying bodies (see FIGS. 4C-4D). Initializing designs on a rectangular grid left a bias for brick-like bodies with square dorsal-anterior and ventral-posterior edges. To mitigate this bias we explored an alternative fitness (loss) function which rounds the edges of the body:

$${ℓ}_{∘} = {\sum }_{φ ∈ Φ} {m}_{φ} ( 2 ( {d}_{φ , ∘} > {r}_{∘} ) - 1 ) \qquad ( 9 )$$

$$ℓ = {ℓ}_{s i m} + {γ}_{∘} \times {ℓ}_{∘} , \qquad ( 10 )$$

where γ_{∘}∈ [0.00001,0.0001]. This additional term promotes the addition of material inside of a circle ∘ of radius r_{∘}, and the removal material outside of it.

Replacing deactivated patches (see FIGS. 4A-4G). When a patch (void or muscle) is removed (reduced to radius zero, moved off the body, or overlapping another patch) it no longer impacts particle mass (in the case of voids) nor actuation (in the case of muscles) and thus no longer receives any gradients from simulation. It remains to determine if deactivating patches in this way caused or could cause premature convergence to suboptimal designs. If it does, a potential solution could be re-placing each removed patch back onto the body at a new, random location, and restoring its initial radius. This strategy was explored for the robots presented in FIGS. 4A-4G.

Agonistic and antagonistic musculature (see FIGS. 4H-4L). Agonistic and antagonistic musculature were implemented using two different sets of muscle patches (sine and cosine) that actuate at the same frequency and amplitude. The actuation state of each particle, ω_{φ,t}, was computed as the harmonic addition of the two channels of actuation (i.e. sine and cosine waves). The contribution from each channel of actuation was computed as described in Eq. 2.

Object manipulation (see FIGS. 4E-4G). A round object of 208 particles (radius 2.5 cm) was added to the simulation, just above the top of the robot, and centered front to back. The robot was then optimized for: locomotion (maximize robot velocity; FIG. 4E), object transportation (maximize average velocity of robot and object; FIG. 4F); and object ejection (maximize velocity of object, FIG. 4G).

Interactive design (see FIGS. 4H-4L). The assumption of an initial rectangular grid was relaxed and replaced with any arbitrary user-supplied 2D shape, such as, but not limited to, triangles (see FIGS. 4H,4I), a circle (see FIG. 4J), a heptagram (see FIG. 4K), enneagram (nine-sided star; see FIG. 4L), and other appropriate shapes.

Constrained actuation (see FIGS. 4A, 4C, 1C-1L). Manufacturing the automatically-designed robot required a post-processing step to be applied to the simulated design after optimization. An additional experiment was thus conducted to determine if this post-processing step could instead be incorporated into the simulation ab initio as a optimization constraint, so that simulated designs could directly be instantiated with closed-bladder actuators. To achieve this, particles close to the border were forbidden from actuating even when they were close to a patch of muscle (see FIG. 4A). To resolve the passive border, the resolution of the simulated robot was increased by a factor of two (128 particles in width and 88 in height; a total of 11264 particles). Starting with the same random initial configuration, a nearly identical morphology emerged after ten design attempts with (see FIG. 4C) and without (see FIGS. 1C-1L) constrained musculature. A slight yet significant increase in fitness was observed in silico when actuation was constrained (p<0.01); however, it is unclear whether or not this is an artifact of the higher particle count (11264 vs 2816 particles).

Direct particle optimization (see FIGS. 4M-4S). The necessity of internal voids for optimizing robot shape can be seen when voids are replaced by a particle-based representation that directly stores and optimizes the mass and elasticity of each particle using gradient descent. Holding all other variables constant, including the use of muscle patches, the direct particle representation yielded robots with significantly lower fitness than that of robots optimized via explicit voids (p<0.01; FIG. 4M). This held true even when the direct particle representation was allowed 40 additional design evaluations (p<0.01). Moreover, without internal voids, shape change did not occur. In every one of the 25 independent trials of direct particle optimization, all initial particles remained part of the body after 50 design evaluations. This is significantly different (p<0.01) to the void-based representation which typically reduces the total present particle count by 6% over the first 10 design attempts (see FIG. 4N).

Intra-void interpolation (see FIGS. 5A-5D and 14E). Each internal void contains a “soft fringe” that gently interpolates erasure, quadratically, from outer edge to mid-center (see FIGS. 2C and 13), prior to fully removing the particles below a mass threshold at their inner core. Some kind of interpolation is required along a void's fringe as a binary step function (fully present particles encircling completely removed particles) would not allow gradients to propagate from simulation to the design parameters (void size and position). This is because, with a step function, given an ε>0, there does not exist any δ>0 where a change of the design parameters by an amount of δ always results in every particle changing its mass by an amount of less than or equal to ε. This property is required for backpropagation.

To evaluate the utility of the soft fringe, additional experiments were conducted in which this quadratic interpolation was replaced with linear and cubic interpolation regimes (see C of FIG. 13). Under these regimes the mass of each particle is set to:

$$d = {min}_{k ∈ K} ( {d}_{φ , k}^{*} , 1 ) \qquad ( 11 )$$

$${m}_{φ} = ( \begin{matrix}0 & if {d}^{q} < λ \\ {d}^{q} & otherwise ,\end{matrix} \qquad ( 12 )$$

with q ∈ {1,2,3} yielding linear, quadratic, and cubic interpolation, respectively (see FIG. 14E), for particles within voids with mass above the threshold of particle inclusion λ ∈ {0.1,0.2,0.4} (see FIG. 14G). In FIG. 5B, λ was set to 0.5 for the linear interpolation function.

The fitness of designs with the soft (quadratic) fringe was significantly higher than that of the hard (linear) fringe (p<0.01). However there was not an appreciable difference in fitness for designs optimized under quadratic and cubic interpolation regimes. While a soft fringe facilitated optimization under the tested conditions, it remains to determine precisely how different interpolation regimes alter the search landscape and gradients.

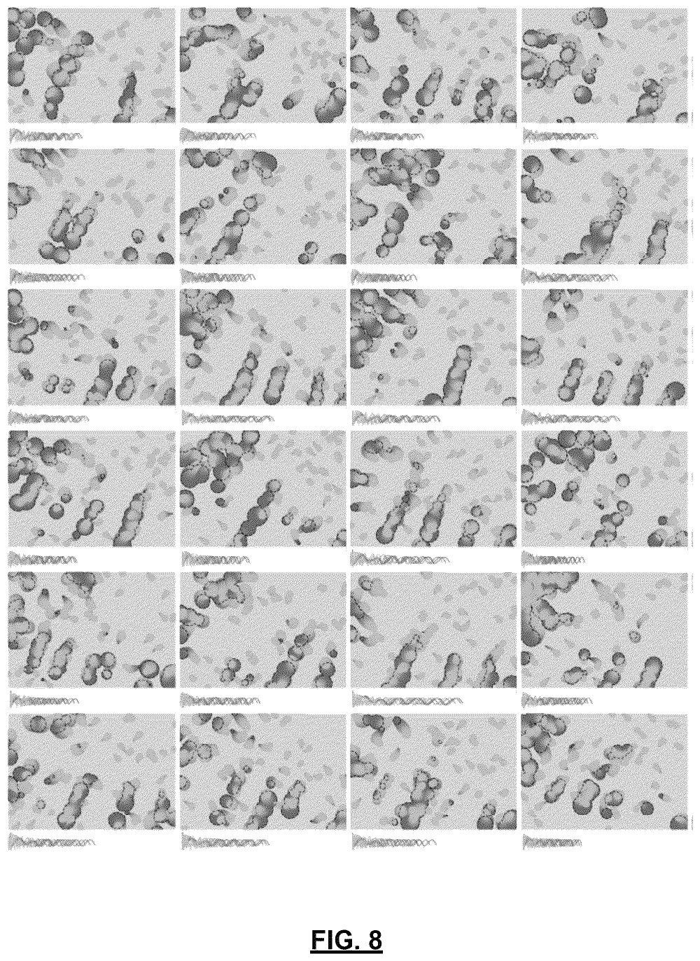

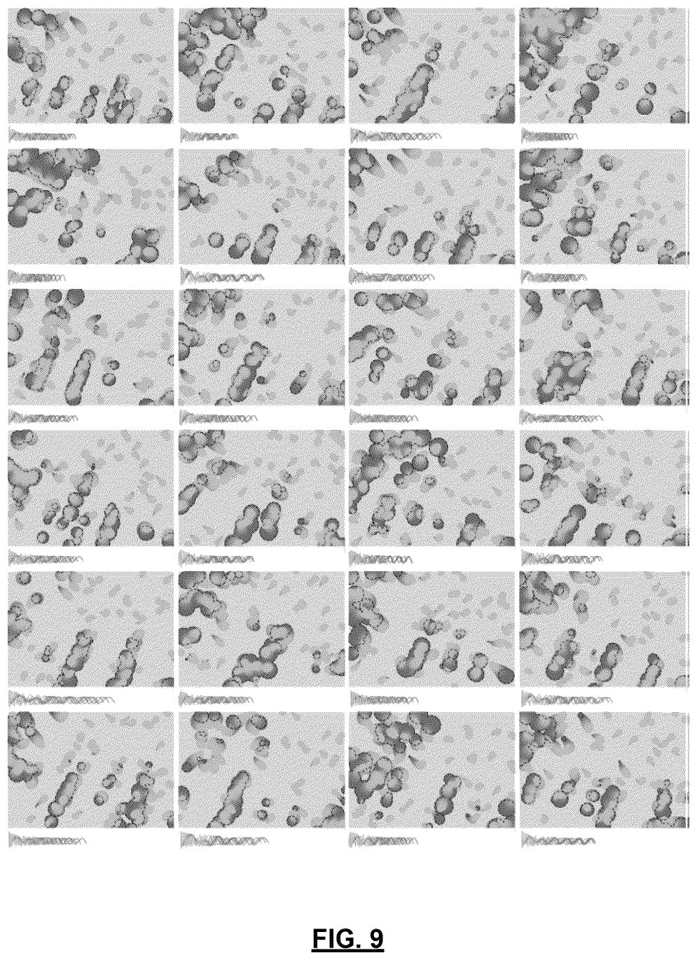

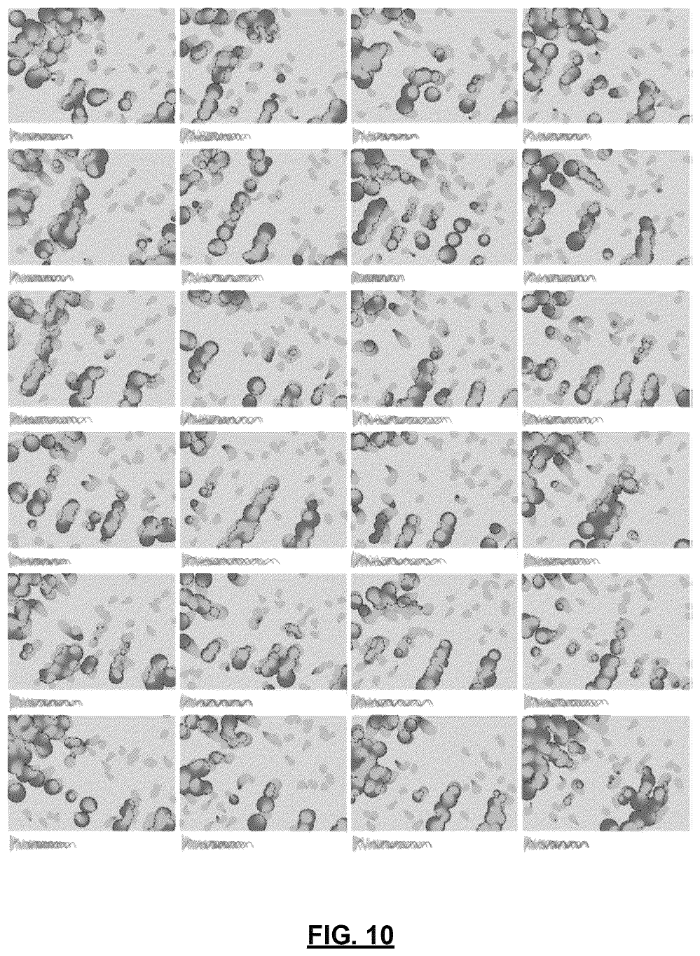

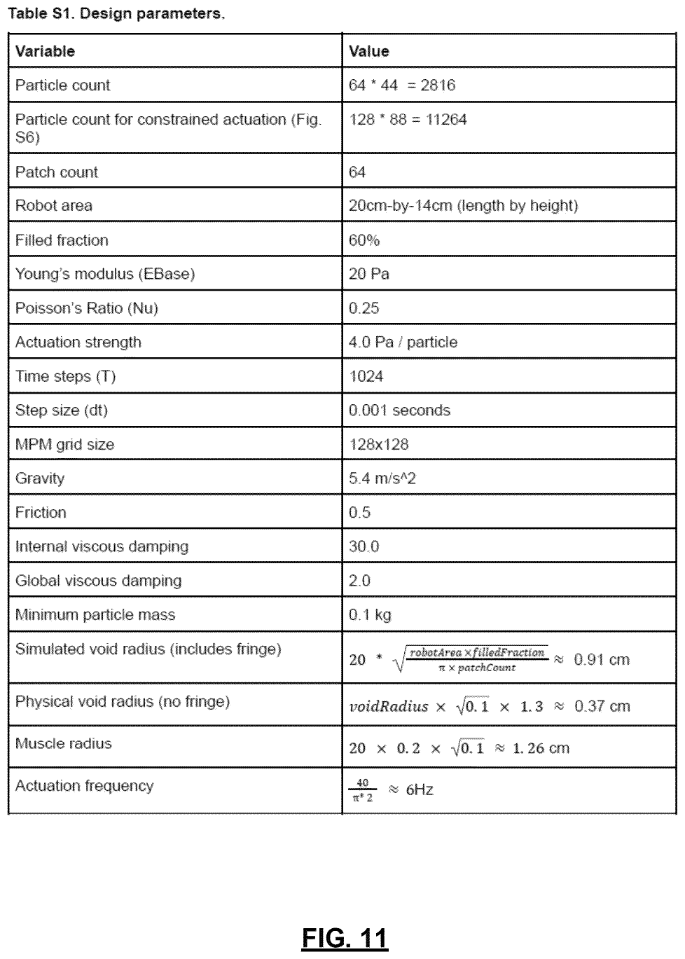

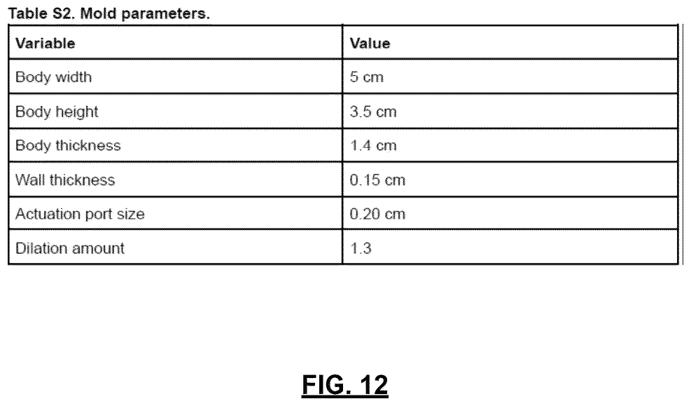

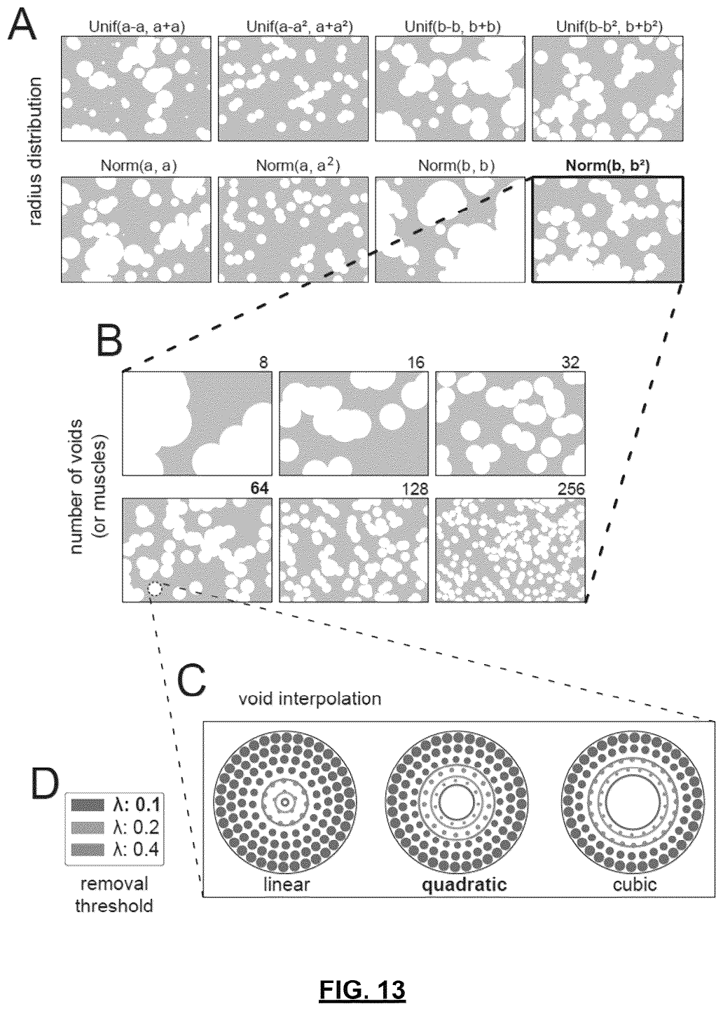

Intra-muscle interpolation (see FIG. 14F). To evaluate the importance of the original quadratic interpolation within each actuator patch, additional experiments were conducted in which the quadratic interpolation was replaced with other interpolation regimes. Under these regimes actuation amplitude of each particle was set to:

$${A}_{φ} = {( 1 - ( {d}_{φ , c}^{*} \times \sqrt{0.1} ) )}^{q} , \qquad ( 13 )$$

where q ∈ {1,2,3}. Gradient descent does not appear to be sensitive to this (or any other tested) hyperparameter and retains supremacy over previous approaches (solid versus dotted lines in FIGS. 8A-8H) in all regimes. Note that different muscle interpolations can generate very different actuation signatures across the robot's body.

Threshold for removal (see FIG. 14G). Particles along the outer fringe of voids decrease in physicality (mass and elasticity) until their mass falls below a threshold, λ, after which they are completely removed from simulation. The physical robot was optimized in simulation with λ=0.1 kg (see FIGS. 2A-2K). Later, two higher (λ=0.2,0.4 kg) thresholds were explored (see FIG. 8G). Fitness slightly (but significantly) decreased when the threshold was raised to 0.2 kg and slightly (but significantly) decreased further when threshold was raised to 0.4 kg. However, different thresholds have different numbers of particles and different material properties. So, this comparison is not “apples to apples” and does not suggest smaller thresholds are better. It does show, however, that gradient descent is not overly sensitive to changes in this hyperparameter, which is interesting since it directly affects the gradients.

Initial void radius distribution (see FIG. 14A).

The distribution of void radii used to design the physical robot was replaced by one of eight other distributions (see A of FIG. 13): Unif (0,2a), Unif (a−a², a+a²), Unif (0,2b), Unif (b-b², b+b²), Norm (a, a), Norm (a, a²), Norm (b, b), Norm (b, b²). When |K| voids are sampled from one of these distributions and arranged side-by-side on a grid, their grid coverage,

$${O}_{K} = \frac{π}{W} {\sum }_{k ∈ K} {r}_{k}^{2} , \qquad ( 14 )$$

will be either O_{K}=30% (when μ=a) or O_{K}=60% (when μ=b) of the robot's body area, W, on average.

Initial muscle radius distribution (see FIG. 14B). The muscle radius used to design the physical robot was replaced by radii sampled from one of the same eight distributions used for voids in Sect. 4. That is: Unif (0,2a), Unif (a−a², a+a²), Unif (0,2b), Unif (b−b², b+b²), Norm (a, a), Norm (a, a²), Norm (b, b), Norm (b, b²). When |C| muscles are sampled from one of these distributions and arranged side-by-side on a grid, their grid coverage, O_{c}, which sums muscle areas in a similar fashion as Eq. 14, will be either O_{c}=57.5% (when μ=a) or O_{c}=115% (when μ=b) of the robot's body area, on average. In practice, however, the muscles always overlap.

Number of voids (see FIG. 14C). The |K|=64 voids used to design the physical robot were replaced by 8, 16, 32, 128, and 256 voids (see B of FIG. 13).

Number of muscles (see FIG. 14D). The |C|=64 muscles used to design the physical robot were replaced by 8, 16, 32, 128, and 256 muscles (see B of FIG. 13).

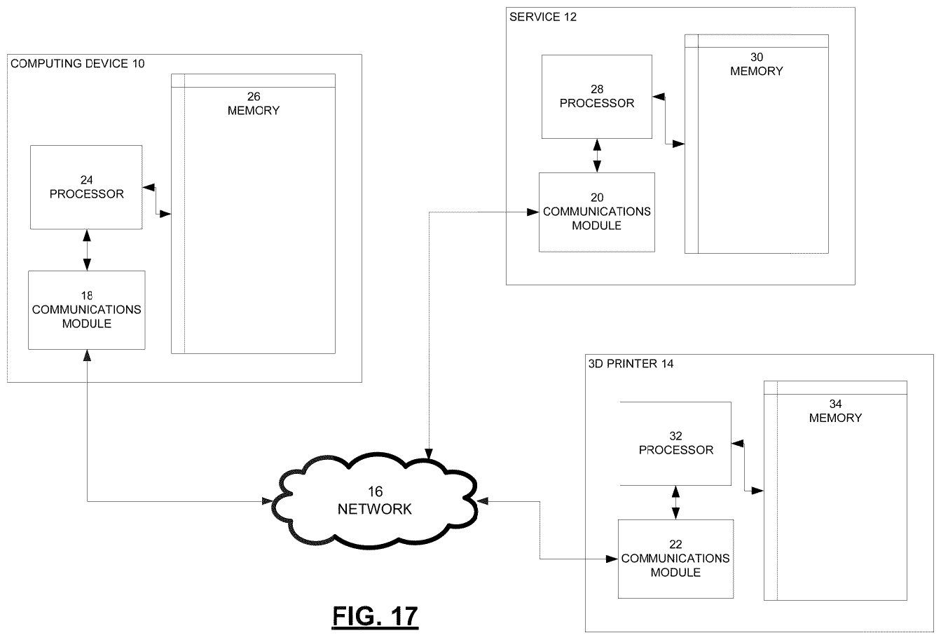

FIG. 17 is a block diagram illustrating an example system 1700 for generating a freeform design of a dynamic system. The example system 1700 includes at least one computing device, such as the computing device 10, the service 12, and, in certain aspects, the 3D printer 14, all connected over a network 16, according to certain aspects of the disclosure.

The computing device 10 can be any device having an appropriate processor, memory, and communications capability for communicating with the service 12 and the 3D printer 14. The computing device 10 to which the service 12 communicates with over the network 16, can be, for example, a tablet computer, a mobile phone, a mobile computer, a laptop computer, a portable media player, an electronic book (eBook) reader, or any other device having appropriate processor, memory, and communications capabilities.

The service 12 can be any device having an appropriate processor, memory, and communications capability for communicating with the computing device 10 and the 3D printer 14. For purposes of load balancing, the service 12 may include multiple servers.

The 3D printer 14 can be any printing device having an appropriate processor, memory, and communications capability for communicating with the computing device 10 and the service 12. In certain aspects, the service 12 can be a cloud computing server of an infrastructure-as-a-service (IaaS) and be able to support a platform-as-a-service (PaaS) and software-as-a-service (SaaS) services.

The network 16 can include, for example, any one or more of a personal area network (PAN), a local area network (LAN), a campus area network (CAN), a metropolitan area network (MAN), a wide area network (WAN), a broadband network (BBN), the Internet, and the like. Further, the network 16 can include, but is not limited to, any one or more of the following network topologies, including a bus network, a star network, a ring network, a mesh network, a star-bus network, tree or hierarchical network, and the like.

The computing device 10, the service 12, and the 3D printer 14 are all connected over the network 16 via respective communication modules 18, 20, 22. The communication modules 18, 20, 22 are configured to interface with the network 16 to send and receive information, such as data, requests, responses, and commands to other devices on the network 16. The communications modules 18, 20, 22 can be, for example, modems or Ethernet cards.

The computing device 10 includes a processor 24, the communications module 18, and a memory 26. The processor 24 of the computing device 10 is configured to execute instructions, such as instructions physically coded into the processor 24, instructions received from software in the memory 26, or a combination of both. The processor 24 of the computing device 10 is configured to perform at least any of its functions described herein.

The service 12 includes a processor 28, the communications module 20, and a memory 30. The processor 28 of the service 12 is configured to execute instructions, such as instructions physically coded into the processor 28, instructions received from software in the memory 30, or a combination of both. The processor 28 of the service 12 is configured to perform at least any of its functions described herein.

The 3D printer 14 includes a processor 32, the communications module 22, and a memory 34. The processor 32 of the 3D printer 14 is configured to execute instructions, such as instructions physically coded into the processor 32, instructions received from software in the memory 34, or a combination of both. The processor 32 of the 3D printer 14 is configured to perform at least any of its functions described herein.

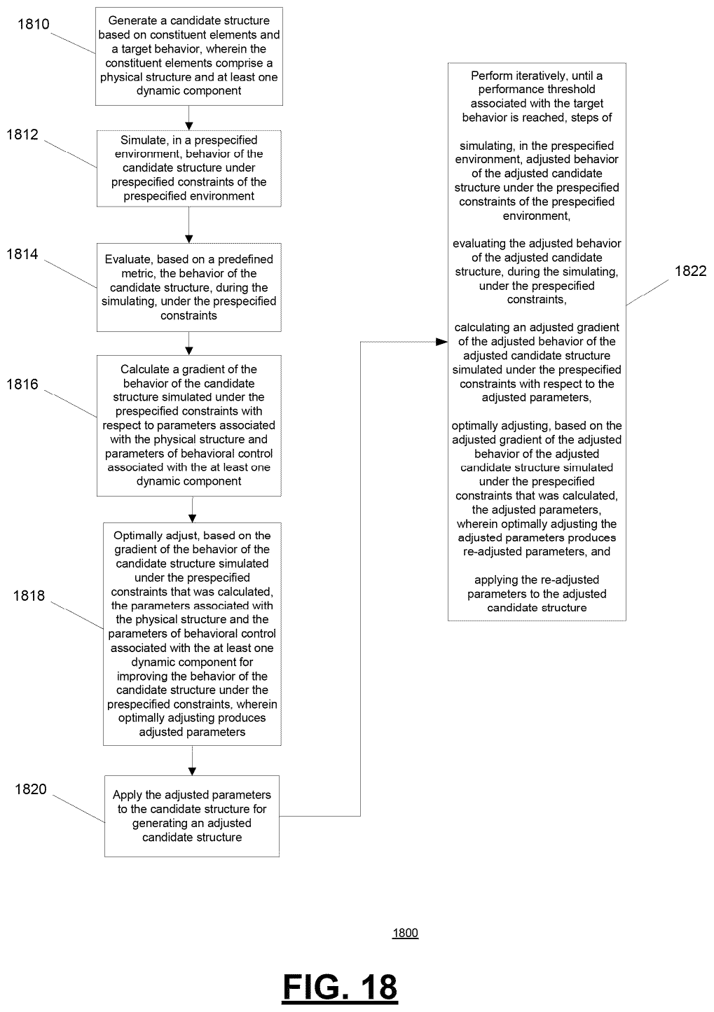

FIG. 18 illustrates an example process 1800 using the computing device 10. It should be understood that the process steps of FIG. 18 may be performed by other systems, as described herein.

The process 1800 begins by proceeding to step 1810 when the processor 24 of the computing device 10 generates a candidate structure based on constituent elements and a target behavior. The constituent elements comprise a physical structure and at least one dynamic component. As depicted at step 1812, the processor 24 of the computing device 10 simulates, in a prespecified environment, behavior of the candidate structure under prespecified constraints of the prespecified environment. As depicted at step 1814, the processor 24 of the computing device 10 evaluates, based on a predefined metric, the behavior of the candidate structure, during the simulating, under the prespecified constraints. The processor 24 of the computing device 10 calculates a gradient of the behavior of the candidate structure simulated under the prespecified constraints with respect to parameters associated with the physical structure and parameters of behavioral control associated with the at least one dynamic component, as depicted at step 1816.

As depicted at step 1818, the processor 24 of the computing device 10 optimally adjusts, based on the gradient of the behavior of the candidate structure simulated under the prespecified constraints that was calculated, the parameters associated with the physical structure and the parameters of behavioral control associated with the at least one dynamic component for improving the behavior of the candidate structure under the prespecified constraints, wherein optimally adjusting produces adjusted parameters. The processor 24 of the computing device 10 apply the adjusted parameters to the candidate structure for generating an adjusted candidate structure, as depicted at step 1820.

As depicted at step 1822, the processor 24 of the computing device 10 performs iteratively, until a performance threshold associated with the target behavior is reached, the steps of: simulating, in the prespecified environment, adjusted behavior of the adjusted candidate structure under the prespecified constraints of the prespecified environment; evaluating the adjusted behavior of the adjusted candidate structure, during the simulating, under the prespecified constraints; calculating an adjusted gradient of the adjusted behavior of the adjusted candidate structure simulated under the prespecified constraints with respect to the adjusted parameters; optimally adjusting, based on the adjusted gradient of the adjusted behavior of the adjusted candidate structure simulated under the prespecified constraints that was calculated, the adjusted parameters, wherein optimally adjusting the adjusted parameters produces re-adjusted parameters; and applying the re-adjusted parameters to the adjusted candidate structure.

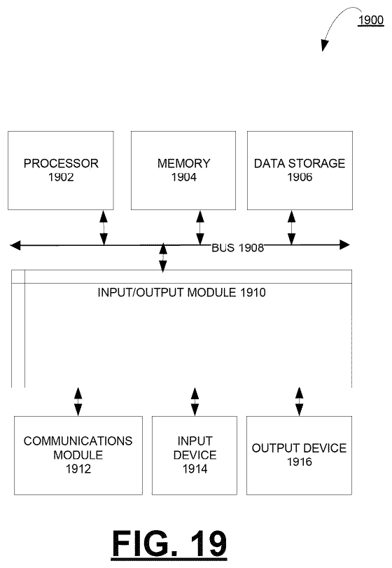

FIG. 19 is a block diagram illustrating an example computer system 1900 with which the computing device 10, the service 12, and the 3D printer 14 of FIG. 17 can be implemented.

Computer system 1900 (e.g., the computing device 10, the service 12, and the 3D printer 14) includes a bus 1908 or other communication mechanism for communicating information, and a processor 1902 (e.g., the processor 24, 28, 32) coupled with bus 1908 for processing information. According to one aspect, the computer system 1900 can be a cloud computing server of an IaaS that is able to support PaaS and SaaS services.

Computer system 1900 can include, in addition to hardware, code that creates an execution environment for the computer program in question, e.g., code that constitutes processor firmware, a protocol stack, a database management system, an operating system, or a combination of one or more of them stored in an included memory 1904 (e.g., the memory 26, 30, 34), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 1908 for storing information and instructions to be executed by processor 1902. The processor 1902 and the memory 1904 can be supplemented by, or incorporated in, special purpose logic circuitry.

The instructions may be stored in the memory 1904 and implemented in one or more computer program products, e.g., one or more modules of computer program instructions encoded on a computer readable medium for execution by, or to control the operation of, the computer system 1900.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 1900 further includes a data storage device 1906 such as a magnetic disk or optical disk, coupled to bus 1908 for storing information and instructions. Computer system 1900 may be coupled via input/output module 1910 to various devices. The input/output module 1910 can be any input/output module. Example input/output modules 1910 include data ports such as USB ports. In addition, input/output module 1910 may be provided in communication with processor 1902, so as to enable near area communication of computer system 1900 with other devices. The input/output module 1910 may provide, for example, for wired communication in some implementations, or for wireless communication in other implementations, and multiple interfaces may also be used. The input/output module 1910 is configured to connect to a communications module 1912. Example communications modules 1912 (e.g., the communications module 18, 20, 22) include networking interface cards, such as Ethernet cards and modems.

In certain aspects, the input/output module 1910 is configured to connect to a plurality of devices, such as an input device 1914 and/or an output device 1916. Example input devices 1914 include a keyboard and a pointing device, e.g., a mouse or a trackball, by which a user can provide input to the computer system 1900. Other kinds of input devices 1914 can be used to provide for interaction with a user as well, such as a tactile input device, visual input device, audio input device, or brain-computer interface device.

According to one aspect of the present disclosure the computing device 10, the service 12, and the 3D printer 14 can be implemented using a computer system 1900 in response to processor 1902 executing one or more sequences of one or more instructions contained in memory 1904. Such instructions may be read into memory 1904 from another machine-readable medium, such as data storage device 1906. Execution of the sequences of instructions contained in main memory 1904 causes processor 1902 to perform the process steps described herein. One or more processors in a multi-processing arrangement may also be employed to execute the sequences of instructions contained in memory 1904. Processor 1902 may process the executable instructions and/or data structures by remotely accessing the computer program product, for example by downloading the executable instructions and/or data structures from a remote server through communications module 1912 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

The term “machine-readable storage medium” or “computer-readable medium” as used herein refers to any medium or media that participates in providing instructions or data to processor 1902 for execution. The term “storage medium” as used herein refers to any non-transitory media that store data and/or instructions that cause a machine to operate in a specific fashion. Such a medium may take many forms, including, but not limited to, non-volatile media, volatile media, and transmission media.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 1908. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in either one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A method for generating a freeform design of a dynamic system, comprising:
generating a candidate structure based on constituent elements and a target behavior, wherein the constituent elements comprise a physical structure and at least one dynamic component;
simulating, in a prespecified environment, behavior of the candidate structure under prespecified constraints of the prespecified environment;
evaluating, based on a predefined metric, the behavior of the candidate structure, during the simulating, under the prespecified constraints;
calculating a gradient of the behavior of the candidate structure simulated under the prespecified constraints with respect to parameters associated with the physical structure and parameters of behavioral control associated with the at least one dynamic component;
optimally adjusting, based on the gradient of the behavior of the candidate structure simulated under the prespecified constraints that was calculated, the parameters associated with the physical structure and the parameters of behavioral control associated with the at least one dynamic component for improving the behavior of the candidate structure under the prespecified constraints, wherein optimally adjusting produces adjusted parameters;
applying the adjusted parameters to the candidate structure for generating an adjusted candidate structure; and
performing iteratively, until a performance threshold associated with the target behavior is reached, steps of
simulating, in the prespecified environment, adjusted behavior of the adjusted candidate structure under the prespecified constraints of the prespecified environment,
evaluating the adjusted behavior of the adjusted candidate structure, during the simulating, under the prespecified constraints,
calculating an adjusted gradient of the adjusted behavior of the adjusted candidate structure simulated under the prespecified constraints with respect to the adjusted parameters,
optimally adjusting, based on the adjusted gradient of the adjusted behavior of the adjusted candidate structure simulated under the prespecified constraints that was calculated, the adjusted parameters,
wherein optimally adjusting the adjusted parameters produces re-adjusted parameters, and
applying the re-adjusted parameters to the adjusted candidate structure.

2. The method of claim 1, wherein the at least one dynamic component comprises at least one actuator.

3. The method of claim 1, wherein the parameters of behavioral control associated with the at least one dynamic component comprise one of a presence, a size, a shape, and a material property.

4. The method of claim 1, wherein the step of generating the candidate structure based on constituent elements comprises generating the candidate structure based on prespecified constituent elements.

5. The method of claim 1, wherein the performance threshold comprises one of a prespecified number of iterations, a prespecified time period, a predetermined performance of the candidate structure, an improvement threshold identifying no further behavioral improvements of the candidate structure, and a prespecified amount of computing resources.

6. The method of claim 1, wherein the step of performing iteratively, until the performance threshold associated with the target behavior is reached, further comprises the step of
optionally calibrating, after applying the re-adjusted parameters to the adjusted candidate structure, the prespecified constraints of the prespecified environment.

7. The method of claim 1, wherein the step of evaluating, based on the predefined metric, the behavior of the candidate structure, during the simulating, under the prespecified constraints is performed via a graphics processing unit.

8. The method of claim 1, wherein the candidate structure models one of an appliance, an instrument, a material, an implant, a wearable, a biological, a vehicle, a turbine, and a robot.

9. The method of claim 1, wherein the step of calculating the gradient of the behavior of the candidate structure simulated under the prespecified constraints with respect to the parameters associated with the physical structure and the parameters of behavioral control associated with the at least one dynamic component further comprises calculating the gradient via an automatic differentiation scheme.

10. The method of claim 1, wherein the step of generating the candidate structure based on constituent elements and the target behavior further comprises generating the candidate structure based on constituent elements via a random distribution.

11. A system comprising:
one or more memories comprising instructions; and
one or more processors configured to execute the instructions, which, when executed, cause the one or more processors to:
generate a candidate structure based on constituent elements and a target behavior, wherein the constituent elements comprise a physical structure and at least one dynamic component;
simulate, in a prespecified environment, behavior of the candidate structure under prespecified constraints of the prespecified environment;
evaluate, based on a predefined metric, the behavior of the candidate structure, during the simulating, under the prespecified constraints;
calculate a gradient of the behavior of the candidate structure simulated under the prespecified constraints with respect to parameters associated with the physical structure and parameters of behavioral control associated with the at least one dynamic component;
optimally adjust, based on the gradient of the behavior of the candidate structure simulated under the prespecified constraints that was calculated, the parameters associated with the physical structure and the parameters of behavioral control associated with the at least one dynamic component for improving the behavior of the candidate structure under the prespecified constraints, wherein optimally adjusting produces adjusted parameters;
apply the adjusted parameters to the candidate structure for generating an adjusted candidate structure; and
perform iteratively, until a performance threshold associated with the target behavior is reached, causing the one or more processors to
simulate, in the prespecified environment, adjusted behavior of the adjusted candidate structure under the prespecified constraints of the prespecified environment,
evaluate the adjusted behavior of the adjusted candidate structure, during the simulating, under the prespecified constraints,
calculate an adjusted gradient of the adjusted behavior of the adjusted candidate structure simulated under the prespecified constraints with respect to the adjusted parameters,
optimally adjust, based on the adjusted gradient of the adjusted behavior of the adjusted candidate structure simulated under the prespecified constraints that was calculated, the adjusted parameters, wherein optimally adjusting the adjusted parameters produces re-adjusted parameters, and
apply the re-adjusted parameters to the adjusted candidate structure.

12. The system of claim 11, wherein the at least one dynamic component comprises at least one actuator.

13. The system of claim 11, wherein the parameters of behavioral control associated with the at least one dynamic component comprise one of a presence, a size, a shape, and a material property.

14. The system of claim 11, wherein the instructions to generate the candidate structure based on constituent elements further comprise instructions to cause the one or more processors to generate the candidate structure based on prespecified constituent elements.

15. The system of claim 11, wherein the performance threshold comprises one of a prespecified number of iterations, a prespecified time period, a predetermined performance of the candidate structure, an improvement threshold identifying no further behavioral improvements of the candidate structure, and a prespecified amount of computing resources.

16. The system of claim 11, wherein the instructions to perform iteratively, until the performance threshold associated with the target behavior is reached, further comprise instructions to optionally calibrate, after applying the re-adjusted parameters to the adjusted candidate structure, the prespecified constraints of the prespecified environment.

17. The system of claim 11, wherein the instructions to evaluate, based on the predefined metric, the behavior of the candidate structure, during the simulating, under the prespecified constraints is performed via a graphics processing unit.

18. The system of claim 11, wherein the candidate structure models one of an appliance, an instrument, a material, an implant, a wearable, a biological, a vehicle, a turbine, and a robot.

19. The system of claim 11, wherein the instructions to calculate the gradient of the behavior of the candidate structure simulated under the prespecified constraints with respect to the parameters associated with the physical structure and the parameters of behavioral control associated with the at least one dynamic component further comprise instructions to calculate the gradient via an automatic differentiation scheme.

20. The system of claim 11, wherein the instructions to generate the candidate structure based on constituent elements and the target behavior further comprise instructions to generate the candidate structure based on constituent elements via a random distribution.
